(19) United States
(12) Patent Application Publication
(10) Pub. No.: US 2025/0250192 A1
(43) Pub. Date: Aug. 7, 2025

(54) COLORED GLASS ARTICLES HAVING IMPROVED MECHANICAL DURABILITY

(71) Applicant: CORNING INCORPORATED, CORNING, NY (US)

(72) Inventors: Xiaoju Guo, Pittsford, NY (US); Karl William Koch, III, Elmira, NY (US); Liping Xiong Smith, Painted Post, NY (US)

(21) Appl. No.: 19/188,401

(22) Filed: Apr. 24, 2025

Related U.S. Application Data
(63) Continuation of application No. 17/841,776, filed on Jun. 16, 2022, now Pat. No. 12,304,858.
(60) Provisional application No. 63/212,179, filed on Jun. 18, 2021.

(51) Int. Cl. C03C 3/093; C03C 4/02; C03C 21/00

(52) U.S. Cl. CPC C03C 3/093; C03C 4/02; C03C 21/00

(57) ABSTRACT

A colored glass article includes greater than or equal to 50 mol % and less than or equal to 70 mol % SiO₂, greater than or equal to 10 mol % and less than or equal to 17.5 mol % Al₂O₃, greater than or equal to 3 mol % and less than or equal to 10 mol % B₂O₃, greater than or equal to 8.8 mol % and less than or equal to 14 mol % Li₂O, greater than or equal to 1.5 mol % and less than or equal to 8 mol % Na₂O, and greater than 0 mol % and less than or equal to 2 mol % Cr₂O₃. R₂O+RO−Al₂O₃ is greater than or equal to 0.5 mol % and less than or equal to 6 mol %. Al₂O₃+MgO+ZnO is greater than or equal to 12 mol % and less than or equal to 22 mol %.

### CROSS-REFERENCE TO RELATED APPLICATIONS

This application is a continuation and claims the benefit of priority under 35 U.S.C. § 120 of U.S. application Ser. No. 17/841,776 filed on Jun. 16, 2022, which in turn, claims the benefit of priority under 35 U.S.C. § 119 of U.S. Provisional Application Ser. No. 63/212,179 filed on Jun. 18, 2021, the contents of each of which are relied upon and incorporated herein by reference in their entireties.

### FIELD

The present specification generally relates to glass compositions and glass articles and, in particular, to glass compositions and ion-exchangeable, colored glass articles formed therefrom.

### TECHNICAL BACKGROUND

Aluminosilicate glass articles may exhibit superior ion-exchangeability and drop performance. Various industries, including the consumer electronics industry, desire colored materials with the same or similar strength and fracture toughness properties. However, simply including colorants in conventional aluminosilicate glass compositions may not produce the desired color.

Accordingly, a need exists for an alternative colored glass articles having high strength and fracture toughness.

### SUMMARY

According to a first aspect A 1, a colored glass article may comprise: greater than or equal to 50 mol % and less than or equal to 70 mol % SiO₂; greater than or equal to 10 mol % and less than or equal to 17.5 mol % Al₂O₃; greater than or equal to 3 mol % and less than or equal to 10 mol % B₂O₃; greater than or equal to 8.8 mol % and less than or equal to 14 mol % Li₂O; greater than or equal to 1.5 mol % and less than or equal to 8 mol % Na₂O; and greater than 0 mol % and less than or equal to 2 mol % Cr₂O₃, wherein: R₂O+RO−Al₂O₃ is greater than or equal to 0.5 mol % and less than or equal to 6 mol %, wherein R₂O is the sum of Li₂O, Na₂O, and K₂O and RO is the sum of MgO, Zno, and CaO; and Al₂O₃+MgO+ZnO is greater than or equal to 12 mol % and less than or equal to 22 mol %.

A second aspect A 2 includes the colored glass article according to the first aspect A 1, wherein the colored glass article has a transmittance color coordinate in the CIELAB color space, as measured at an article thickness of 1.5 mm under F2 illumination and a 10° standard observer angle, of: L* greater than or equal to 0 and less than or equal to 100; a* greater than or equal to −18 and less than or equal to 0; and b* greater than or equal to 0 and less than or equal to 82.

A third aspect A 3 includes the colored glass article according to the first aspect A 1 or the second aspect A 2, wherein MgO+ZnO is greater than or equal to 0 mol % and less than or equal to 4.5 mol %.

A fourth aspect A 4 includes the colored glass article according to the third aspect A 3, wherein MgO+ZnO is greater than or equal to 0 mol % and less than or equal to 1 mol %.

A fifth aspect A 5 includes the colored glass article according to the third aspect A 3, wherein MgO+ZnO is greater than or equal to 1 mol % and less than or equal to 4.5 mol %.

A sixth aspect A 6 includes the colored glass article according to any one of the first through fifth aspects A 1-A 5, wherein R₂O+RO−Al₂O₃ is greater than or equal to 1 mol % and less than or equal to 5.5 mol %.

A seventh aspect A 7 includes the colored glass article according to any one of the first through sixth aspects A 1-A 6, wherein Al₂O₃+MgO+ZnO is greater than or equal to is greater than or equal to 13 mol % and less than or equal to 21.5 mol %.

An eighth aspect A 8 includes the colored glass article according to any one of the first through seventh aspects A 1-A 7, wherein the colored glass article comprises greater than or equal to 0.001 mol % and less than or equal to 1.5 mol % Cr₂O₃.

A ninth aspect A 9 includes the colored glass article according to any one of the first through eighth aspects A 1-A 8, wherein the colored glass article comprises greater than or equal to 12 mol % and less than or equal to 17.25 mol % Al₂O₃.

A tenth aspect A 10 includes the colored glass article according to any one of the first through ninth aspects A 1-A 9, wherein the colored glass article comprises greater than or equal to 3.5 mol % and less than or equal to 9 mol % B₂O₃.

An eleventh aspect A 11 includes the colored glass article according to any one of the first through tenth aspects A 1-A 10, wherein the colored glass article comprises greater than or equal to 9 mol % and less than or equal to 13.5 mol % Li₂O.

A twelfth aspect A 12 includes the colored glass article according to any one of the first through eleventh aspects A 1-A 11, wherein the colored glass article comprises greater than or equal to 2 mol % and less than or equal to 7.5 mol % Na₂O.

A thirteenth aspect A 13 includes the colored glass article according to any one of the first through twelfth aspects A 1-A 12, wherein the colored glass article comprises: greater than or equal to 0 mol % and less than or equal to 4.5 mol % MgO; greater than or equal to 0 mol % and less than or equal to 4.5 mol % ZnO; and greater than or equal to 0 mol % and less than or equal to 2 mol % CaO.

A fourteenth aspect A 14 includes the colored glass article according to any one of the first through thirteenth aspects A 1-A 13, wherein the colored glass article comprises greater than or equal to 0 mol % and less than or equal to 3 mol % K₂O.

A fifteenth aspect A 15 includes the colored glass article according to any one of the first through fourteenth aspects A 1-A 14, wherein the colored glass article comprises greater than or equal to 53 mol % and less than or equal to 67 mol % SiO₂.

A sixteenth aspect A 16 includes the colored glass article according to any one of the first through fifteenth aspects A 1-A 15, wherein: the colored glass article comprises greater than or equal to 0 mol % and less than or equal to 4 mol % NiO; and the colored glass article has a transmittance color coordinate in the CIELAB color space, as measured at an article thickness of 1.5 mm under F2 illumination and a 10° standard observer angle, of: L* greater than or equal to 0 and less than or equal to 100; a* greater than or equal to −18 and less than or equal to 18; and b* greater than or equal to 0 and less than or equal to 82.

A seventeenth aspect A 17 includes the colored glass article according to any one of the first through fifteenth aspects A 1-A 15, wherein: the colored glass article comprises greater than or equal to 0 mol % and less than or equal to 2 mol % Co₃O₄; and the colored glass article has a transmittance color coordinate in the CIELAB color space, as measured at an article thickness of 1.5 mm under F2 illumination and a 10° standard observer angle, of: L* greater than or equal to 0 and less than or equal to 100; a* greater than or equal to −20 and less than or equal to 60; and b* greater than or equal to −90 and less than or equal to 85.

An eighteenth aspect A 18 includes the colored glass article according to any one of the first through fifteenth aspects A 1-A 15, wherein: the colored glass article comprises greater than or equal to 0 mol % and less than or equal to 20 mol % CuO; and the colored glass article has a transmittance color coordinate in the CIELAB color space, as measured at an article thickness of 1.5 mm under F2 illumination and a 10° standard observer angle, of: L* greater than or equal to 0 and less than or equal to 100; a greater than or equal to −35 and less than or equal to 0; and b* greater than or equal to 0 and less than or equal to 82.

A nineteenth aspect A 19 includes the colored glass article according to any one of the first through fifteenth aspects A 1-A 15, wherein: the colored glass article comprises greater than or equal to 0 mol % and less than or equal to 4 mol % NiO and greater than or equal to 0 mol % and less than or equal to 20 mol % CuO; and the colored glass article has a transmittance color coordinate in the CIELAB color space, as measured at an article thickness of 1.5 mm under F2 illumination and a 10° standard observer angle, of: L* greater than or equal to 0 and less than or equal to 100; a greater than or equal to −35 and less than or equal to 20; and b* greater than or equal to 0 and less than or equal to 75.

A twentieth aspect A 20 includes the colored glass article according to any one of the first through fifteenth aspects A 1-A 15 wherein: the colored glass article comprises greater than or equal to 0 mol % and less than or equal to 4 mol % NiO and greater than or equal to 0 mol % and less than or equal to 2 mol % Co₃O₄; and the colored glass article has a transmittance color coordinate in the CIELAB color space, as measured at an article thickness of 1.5 mm under F2 illumination and a 10° standard observer angle, of: L* greater than or equal to 0 and less than or equal to 100; a* greater than or equal to −15 and less than or equal to 65; and b* greater than or equal to −90 and less than or equal to 80.

A twenty-first aspect A 21 includes the colored glass article according to any one of the first through fifteenth aspects A 1-A 15, wherein: the colored glass article comprises greater than or equal to 0 mol % and less than or equal to 20 mol % CuO and greater than or equal to 0 mol % and less than or equal to 2 mol % Co₃O₄; and the colored glass article has a transmittance color coordinate in the CIELAB color space, as measured at an article thickness of 1.5 mm under F2 illumination and a 10° standard observer angle, of: L* greater than or equal to 0 and less than or equal to 100; a* greater than or equal to −35 and less than or equal to 60; and b* greater than or equal to −90 and less than or equal to 80.

A twenty-second aspect A 22 includes the colored glass article according to any one of the first through fifteenth aspects A 1-A 15, wherein: the colored glass article comprises greater than or equal to 0 mol % and less than or equal to 4 mol % NiO, greater than or equal to 0 mol % and less than or equal to 20 mol % CuO, greater than or equal to 0 mol % and less than or equal to 2 mol % Co₃O₄; and the colored glass article has a transmittance color coordinate in the CIELAB color space, as measured at an article thickness of 1.5 mm under F2 illumination and a 10° standard observer angle, of: L* greater than or equal to 0 and less than or equal to 100; a* greater than or equal to −35 and less than or equal to 60; and b* greater than or equal to −90 and less than or equal to 80

A twenty-third aspect A 23 includes the colored glass article according to any one of the first through fifteenth aspects A 1-A 15, wherein the colored glass article has a K_{1C} fracture toughness as measured by a chevron notch short bar method of greater than or equal to 0.7M Pa*m^{0.5}.

A twenty-fourth aspect A 24 includes the colored glass article according to any one of the first through fifteenth aspects A 1-A 15, wherein the colored glass article is a chemically strengthened glass article.

A twenty-fifth aspect A 25 includes the colored glass article according to the twenty-fourth aspect A 24, wherein the colored glass article has a surface compressive stress greater than or equal to 300 M Pa.

A twenty-sixth aspect A 26 includes the colored glass article according to the twenty-fourth aspect A 24 or the twenty-fifth aspect A 25, wherein the colored glass article has a maximum central tension greater than or equal to 40 M Pa.

A twenty-seventh aspect A 27 includes the colored glass article according to any one of the twenty-fourth through twenty-sixth aspects A 24-A 26, wherein the colored glass article has a depth of compression greater than or equal to 0.15 t.

According to a twenty-eighth aspect A 28, a consumer electronic device may comprise: a housing having a front surface, a back surface, and side surfaces; and electrical components provided at least partially within the housing, the electrical components including at least a controller, a memory, and a display, the display being provided at or adjacent the front surface of the housing; wherein the back surface comprises the colored glass article of any one of aspects 1-27.

According to a twenty-ninth aspect A 29, a glass composition may comprise: greater than or equal to 50 mol % and less than or equal to 70 mol % SiO₂; greater than or equal to 10 mol % and less than or equal to 17.5 mol % Al₂O₃; greater than or equal to 3 mol % and less than or equal to 10 mol % B₂O₃; greater than or equal to 8.8 mol % and less than or equal to 14 mol % Li₂O; greater than or equal to 1.5 mol % and less than or equal to 8 mol % Na₂O; and greater than 0 mol % and less than or equal to 0.2 mol % Cr₂O₃, wherein: R₂O+RO−Al₂O₃ is greater than or equal to 0.5 mol % and less than or equal to 6 mol %, wherein R₂O is the sum of Li₂O, Na₂O, and K₂O and RO is the sum of MgO, ZnO, and CaO; and Al₂O₃+MgO+ZnO is greater than or equal to 12 mol % and less than or equal to 22 mol %.

A thirtieth aspect A 30 includes the glass composition according to the twenty-ninth aspect A 29, wherein MgO+ZnO is greater than or equal to 0 mol % and less than or equal to 4.5 mol %.

A thirty-first aspect A 31 includes the glass composition according to the thirtieth aspect A 30, wherein MgO+ZnO is greater than or equal to 0 mol % and less than or equal to 1 mol %.

A thirty-second aspect A 32 includes the glass composition according to the thirtieth aspect A 30, wherein MgO+ZnO is greater than or equal to 1 mol % and less than or equal to 4.5 mol %.

A thirty-third aspect A 33 includes the glass composition according to any one of the twenty-ninth through thirty-second aspects A 29-A 32, wherein R₂O+RO−Al₂O₃ is greater than or equal to 1 mol % and less than or equal to 5.5 mol %.

A thirty-fourth aspect A 34 includes the glass composition according to any one of the twenty-ninth through thirty-third aspects A 29-A 33, wherein A 1203+MgO+ZnO is greater than or equal to is greater than or equal to 14 mol % and less than or equal to 20 mol %.

A thirty-fifth aspect A 35 includes the glass composition according to any one of the twenty-ninth through thirty-fourth aspects A 29-A 34, wherein the glass composition comprises greater than or equal to 0.001 mol % and less than or equal to 1.5 mol % Cr₂O₃.

A thirty-sixth aspect A 36 includes the glass composition according to any one of the twenty-ninth through thirty-fiftieth aspects A 29-A 35, wherein the glass composition comprises greater than or equal to 12 mol % and less than or equal to 17 mol % Al₂O₃.

A thirty-seventh aspect A 37 includes the glass composition according to any one of the twenty-ninth through thirty-sixth aspects A 29-A 36, wherein the glass composition comprises greater than or equal to 4 mol % and less than or equal to 8 mol % B₂O₃.

A thirty-eighth aspect A 38 includes the glass composition according to any one of the twenty-ninth through thirty-seventh aspects A 29-A 37, wherein the glass composition comprises greater than or equal to 9 mol % and less than or equal to 13 mol % Li₂O.

A thirty-ninth aspect A 39 includes the glass composition according to any one of the twenty-ninth through thirty-eighth aspects A 29-A 38, wherein the glass composition comprises greater than or equal to 3 mol % and less than or equal to 7 mol % Na₂O.

A fortieth aspect A 40 includes the glass composition according to any one of the twenty-ninth through thirty-ninth aspects A 29-A 39, wherein the glass composition comprises: greater than or equal to 0 mol % and less than or equal to 4.5 mol % MgO; greater than or equal to 0 mol % and less than or equal to 4.5 mol % ZnO; and greater than or equal to 0 mol % and less than or equal to 2 mol % CaO.

A forty-first aspect A 41 includes the glass composition according to any one of the twenty-ninth through fortieth aspects A 29-A 40, wherein the glass composition comprises greater than or equal to 0 mol % and less than or equal to 3 mol % K₂O.

A forty-second aspect A 42 includes the glass composition according to any one of the twenty-ninth through forty-first aspects A 29-A 41, wherein the glass composition comprises greater than or equal to 53 mol % and less than or equal to 65 mol % SiO₂.

A forty-third aspect A 43 includes the glass composition according to any one of the twenty-ninth through forty-second aspects A 29-A 42, wherein the glass composition comprises NiO, CuO, Co₃O₄, or combinations thereof.

Additional features and advantages of the colored glass articles described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 is a plot of a projected a* vs. b* CIELAB space (x-axis: a*; y-axis: b*) of a colored glass article made from a glass composition according to one or more embodiments described herein;

FIG. 2 is a plot of a projected a* vs. L* CIELAB space (x-axis: a*; y-axis: L*) of the colored glass article of FIG. 1;

FIG. 3 is a plot of a projected b* vs. L* CIELAB space (x-axis: b*; y-axis: L*) of the colored glass article of FIG. 1;

FIG. 4 is a plot of a projected a* vs. b* CIELAB space (x-axis: a*; y-axis: b*) of a colored glass article made from a glass composition according to one or more embodiments described herein;

FIG. 5 is a plot of a projected a* vs. L* CIELAB space (x-axis: a*; y-axis: L*) of the colored glass article of FIG. 4;

FIG. 6 is a plot of a projected b* vs. L* CIELAB space (x-axis: b*; y-axis: L*) of the colored glass article of FIG. 4;

FIG. 7 is a plot of a projected a* vs. b* CIELAB space (x-axis: a*; y-axis: b*) of a colored glass article made from a glass composition according to one or more embodiments described herein;

FIG. 8 is a plot of a projected a* vs. L* CIELAB space (x-axis: a*; y-axis: L*) of the colored glass article of FIG. 7;

FIG. 9 is a plot of a projected b* vs. L* CIELAB space (x-axis: b*; y-axis: L*) of the colored glass article of FIG. 7;

FIG. 10 is a plot of a projected a* vs. b* CIELAB space (x-axis: a*; y-axis: b*) of a colored glass article made from a glass composition according to one or more embodiments described herein;

FIG. 11 is a plot of a projected a* vs. L* CIELAB space (x-axis: a*; y-axis: L*) of the colored glass article of FIG. 10;

FIG. 12 is a plot of a projected b* vs. L* CIELAB space (x-axis: b*; y-axis: L*) of the colored glass article of FIG. 10;

FIG. 13 is a plot of a projected a* vs. b* CIELAB space (x-axis: a*; y-axis: b*) of a colored glass article made from a glass composition according to one or more embodiments described herein;

FIG. 14 is a plot of a projected a* vs. L* CIELAB space (x-axis: a*; y-axis: L*) of the colored glass article of FIG. 13;

FIG. 15 is a plot of a projected b* vs. L* CIELAB space (x-axis: b*; y-axis: L*) of the colored glass article of FIG. 13;

FIG. 16 is a plot of a projected a* vs. b* CIELAB space (x-axis: a*; y-axis: b*) of a colored glass article made from a glass composition according to one or more embodiments described herein;

FIG. 17 is a plot of a projected a* vs. L* CIELAB space (x-axis: a*; y-axis: L*) of the colored glass article of FIG. 16;

FIG. 18 is a plot of a projected b* vs. L* CIELAB space (x-axis: b*; y-axis: L*) of the colored glass article of FIG. 16;

FIG. 19 is a plot of a projected a* vs. b* CIELAB space (x-axis: a*; y-axis: b*) of a colored glass article made from a glass composition according to one or more embodiments described herein;

FIG. 20 is a plot of a projected a* vs. L* CIELAB space (x-axis: a*; y-axis: L*) of the colored glass article of FIG. 19;

FIG. 21 is a plot of a projected b* vs. L* CIELAB space (x-axis: b*; y-axis: L*) of the colored glass article of FIG. 19;

FIG. 22 is a plot of a projected a* vs. b* CIELAB space (x-axis: a*; y-axis: b*) of a colored glass article made from a glass composition according to one or more embodiments described herein;

FIG. 23 is a plot of a projected a* vs. L* CIELAB space (x-axis: a*; y-axis: L*) of the colored glass article of FIG. 22;

FIG. 24 is a plot of a projected b* vs. L* CIELAB space (x-axis: b*; y-axis: L*) of the colored glass article of FIG. 22;

FIG. 25 is a plan view of an electronic device incorporating any of the colored glass articles according to one or more embodiments described herein; and

FIG. 26 is a perspective view of the electronic device of FIG. 25.

### DETAILED DESCRIPTION

Reference will now be made in detail to various embodiments of glass compositions and colored glass articles formed therefrom having a desired color. According to embodiments, a colored glass article includes greater than or equal to 50 mol % and less than or equal to 70 mol % SiO₂, greater than or equal to 10 mol % and less than or equal to 17.5 mol % Al₂O₃, greater than or equal to 3 mol % and less than or equal to 10 mol % B₂O₃, greater than or equal to 8.8 mol % and less than or equal to 14 mol % Li₂O, greater than or equal to 1.5 mol % and less than or equal to 8 mol % Na₂O, and greater than 0 mol % and less than or equal to 2 mol % Cr₂O₃. R₂O+RO−Al₂O₃ is greater than or equal to 0.5 mol % and less than or equal to 6 mol %. R₂O is the sum of Li₂O, Na₂O, and K₂O and RO is the sum of MgO, ZnO, and CaO. Al₂O₃+MgO+ZnO is greater than or equal to 12 mol % and less than or equal to 22 mol %. Various embodiments of colored glass articles and methods of making the same will be described herein with specific reference to the appended drawings.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

In the embodiments of the glass compositions described herein, the concentrations of constituent components (e.g., SiO₂, Al₂O₃, and the like) are specified in mole percent (mol %) on an oxide basis, unless otherwise specified.

The term “fracture toughness,” as used herein, refers to the K_{1C} value, and is measured by the chevron notched short bar method. The chevron notched short bar (CNSB) method is disclosed in Reddy, K. P. R. et al, “Fracture Toughness Measurement of Glass and Ceramic Materials Using Chevron-Notched Specimens,” J. Am. Ceram. Soc., 71 [6], C-310-C-313 (1988) except that Y*ₘ is calculated using equation 5 of Bubsey, R. T. et al., “Closed-Form Expressions for Crack-Mouth Displacement and Stress Intensity Factors for Chevron-Notched Short Bar and Short Rod Specimens Based on Experimental Compliance Measurements,” NASA Technical Memorandum 83796, pp. 1-30 (October 1992).

The term “melting point,” as used herein, refers to the temperature at which the viscosity of the glass composition is 200 poise.

The term “softening point,” as used herein, refers to the temperature at which the viscosity of the glass composition is 1×10^{7.6} poise. The softening point is measured according to the parallel plate viscosity method which measures the viscosity of inorganic glass from 10⁷ to 10⁹ poise as a function of temperature, similar to ASTM C1351M.

The terms “annealing point” as used herein, refer to the temperature at which the viscosity of the glass composition is 1×10^{13.18} poise.

The term “strain point,” as used herein, refers to the temperature at which the viscosity of the glass composition is 1×10^{14.68} poise.

The term “linear coefficient of thermal expansion” and “CTE,” as described herein, is measured in accordance with ASTM E228-85 over the temperature range of 25° C. to 300° C. and is expressed in terms of “x 10⁻⁷/° C.”

The term “liquidus viscosity,” as used herein, refers to the viscosity of the glass composition at the onset of devitrification (i.e., at the liquidus temperature as determined with the gradient furnace method according to ASTM C829-81).

The term “liquidus temperature,” as used herein, refers to the temperature at which the glass composition begins to devitrify as determined with the gradient furnace method according to ASTM C829-81.

Surface compressive stress is measured with a surface stress meter (FSM) such as commercially available instruments such as the FSM-6000, manufactured by Orihara Industrial Co., Ltd. (Japan). Surface stress measurements rely upon the measurement of the stress optical coefficient (SOC), which is related to the birefringence of the glass article. SOC, in turn, is measured according to Procedure C (Glass Disc Method) described in ASTM standard C770-16, entitled “Standard Test Method for Measurement of Glass Stress-Optical Coefficient,” the contents of which are incorporated herein by reference in their entirety. Depth of compression (DOC) is also measured with the FSM. The maximum central tension (CT) values are measured using a scattered light polariscope (SCALP) technique known in the art.

The phrase “depth of compression” (DOC), as used herein, refers to the position in the article where compressive stress transitions to tensile stress.

The term “CIELAB color space,” as used herein, refers to a color space defined by the International Commission on Illumination (CIE) in 1976. It expresses color as three values: L* for the lightness from black (0) to white (100), a* from green (−) to red (+), and B* from blue (−) to yellow (+).

The term “color gamut,” as used herein, refers to the pallet of colors that may be achieved by the colored glass articles within the CIELAB color space.

The term “projected color gamut,” as used herein, refers to the line, surface, volume, or overlapping volume occupied by the colored glass article within the three-dimensional CIELAB color space and represents the pallet of colors that may be achieved by the colored glass articles within the CIELAB color space based upon the concentration of colorant(s) present in the colored glass article. The projected color gamuts shown herein were produced using the plotting routine Gnuplot Version 5.4. Specifically, Gnuplot was used to display projections of the CIELAB color coordinates for the transmitted colors under F2 illumination for the CIE 1976 10° Standard Observer. The transmittance spectrum through a flat sheet of glass is given by the following expression:

$$T ( λ ) = \frac{{[ 1 - R ( λ ) ]}^{2} \times exp [ - {\sum }_{i} {N}_{i} {σ}_{i} ( λ ) t ]}{1 - {R ( λ )}^{2} \times exp [ - 2 {\sum }_{i} {N}_{i} {σ}_{i} ( λ ) t ]} ,$$

where R is the Fresnel intensity reflection coefficient of the glass, Nᵢ and σᵢ represent the number density and absorption cross section, respectively, for the individual dopants, A is the optical wavelength, and t is the thickness of the glass. The color coordinates were calculated from the transmittance spectra through 1.5-mm of the colored glass article. The expression for the transmittance was evaluated by varying the dopant concentrations (Nᵢ) for the combinations of the colorants from 0 to a maximum value. As described herein, the maximum values for Cr₂O₃, NiO, CuO, and Co₃O₄ were set to 2 mol %, 4 mol %, 20 mol %, and 2 mol %, respectively.

Colorants have been added to conventional aluminosilicate glass compositions to achieve a colored glass article having a desired color and improved mechanical properties. For example, chromium (Cr) doped glass articles are green. However, simply including colorants in aluminosilicate glass compositions may not produce the desired color. For example, a conventional aluminosilicate glass composition C1 may include 58.4 mol % SiO₂, 17.8 mol % A/203, 6.07 mol % B 203, 10.7 mol % Li₂O, 1.7 mol % Na₂O, 0.2 mol % K 20, 4.43 mol % MgO, and 0.57 mol % CaO. Cr₂O₃ added to this conventional aluminosilicate glass composition would have low solubility and would form Cr/Mg/Zn spinel crystals because of the greater amounts of Al₂O₃, MgO, and ZnO present in the composition. The low solubility of Cr₂O₃ limits the color gamut that may be achieved and may, at most, result in a glass article having a faint green hue.

Disclosed herein are glass compositions and colored glass articles formed therefrom that mitigate the aforementioned problems such that Cr₂O₃ may be added to aluminosilicate glass compositions to produce colored glass articles having the desired color while retaining the superior ion-exchangeability and drop performance of the colored glass articles. Specifically, the glass compositions disclosed herein improve Cr₂O₃ solubility by including a limited amount of Al₂O₃ (e.g., less than or equal to 17.5 mol % Al₂O₃ and/or R₂O+RO−Al₂O₃ greater than or equal to 0.5 mol %) and a limited total amount of Al₂O₃, MgO, and ZnO (e.g., Al₂O₃+MgO+ZnO less than or equal to 22 mol %). Increasing the solubility of Cr₂O₃ expands the color gamut that may be achieved by the resultant colored glass articles.

The glass compositions and colored glass articles described herein may be described as aluminoborosilicate glass compositions and colored glass articles and comprise SiO₂, Al₂O₃, and B₂O₃. In addition to SiO₂, Al₂O₃, and B₂O₃, the glass compositions and colored glass articles described herein include Cr₂O₃ to produce colored glass articles having the desired color. The glass compositions and colored glass articles described herein also include alkali oxides, such as Li₂O and Na₂O, to enable the ion-exchangeability of the colored glass articles.

SiO₂ is the primary glass former in the glass compositions described herein and may function to stabilize the network structure of the colored glass articles. The concentration of SiO₂ in the glass compositions and resultant colored glass articles should be sufficiently high (e.g., greater than or equal to 50 mol %) to enhance the chemical durability of the glass composition and, in particular, the resistance of the glass composition to degradation upon exposure to acidic solutions, basic solutions, and in water. The amount of SiO₂ may be limited (e.g., to less than or equal to 70 mol %) to control the melting point of the glass composition, as the melting temperature of pure SiO₂ or high SiO₂ glasses is undesirably high. Thus, limiting the concentration of SiO₂ may aid in improving the meltability and the formability of the resultant colored glass article.

Accordingly, in embodiments, the glass composition and the resultant colored glass article may comprise greater than or equal to 50 mol % and less than or equal to 70 mol % SiO₂. In embodiments, the glass composition and the resultant colored glass article may comprise greater than or equal to 53 mol % and less than or equal to 67 mol % SiO₂. In embodiments, the concentration of SiO₂ in the glass composition and the resultant colored glass article may be greater than or equal to 50 mol %, greater than or equal to 53 mol %, greater than or equal to 55 mol %, greater than or equal to 56 mol %, or even greater than or equal to 57 mol %. In embodiments, the concentration of SiO₂ in the glass composition and the colored resultant glass article may be less than or equal to 70 mol %, less than or equal to 67 mol %, less than or equal to 65 mol %, less than or equal to 63 mol %, less than or equal to 60 mol %, or even less than or equal to 59 mol %. In embodiments, the concentration of SiO₂ in the glass composition and the resultant colored glass article may be greater than or equal to 50 mol % and less than or equal to 70 mol %, greater than or equal to 50 mol % and less than or equal to 67 mol %, greater than or equal to 50 mol % and less than or equal to 65 mol %, greater than or equal to 50 mol % and less than or equal to 63 mol %, greater than or equal to 50 mol % and less than or equal to 60 mol %, greater than or equal 50 mol % and less than or equal to 59 mol %, greater than or equal to 53 mol % and less than or equal to 70 mol %, greater than or equal to 53 mol % and less than or equal to 67 mol %, greater than or equal to 53 mol % and less than or equal to 65 mol %, greater than or equal to 53 mol % and less than or equal to 63 mol %, greater than or equal to 53 mol % and less than or equal to 60 mol %, greater than or equal 53 mol % and less than or equal to 59 mol %, greater than or equal to 55 mol % and less than or equal to 70 mol %, greater than or equal to 55 mol % and less than or equal to 67 mol %, greater than or equal to 55 mol % and less than or equal to 65 mol %, greater than or equal to 55 mol % and less than or equal to 63 mol %, greater than or equal to 55 mol % and less than or equal to 60 mol %, greater than or equal 55 mol % and less than or equal to 59 mol %, greater than or equal to 56 mol % and less than or equal to 70 mol %, greater than or equal to 56 mol % and less than or equal to 67 mol %, greater than or equal to 56 mol % and less than or equal to 65 mol %, greater than or equal to 56 mol % and less than or equal to 63 mol %, greater than or equal to 56 mol % and less than or equal to 60 mol %, greater than or equal 56 mol % and less than or equal to 59 mol %, greater than or equal to 57 mol % and less than or equal to 70 mol %, greater than or equal to 57 mol % and less than or equal to 67 mol %, greater than or equal to 57 mol % and less than or equal to 65 mol %, greater than or equal to 57 mol % and less than or equal to 63 mol %, greater than or equal to 57 mol % and less than or equal to 60 mol %, or even greater than or equal 57 mol % and less than or equal to 59 mol %, or any and all sub-ranges formed from these endpoints.

Like SiO₂, Al₂O₃ may also stabilize the glass network and additionally provides improved mechanical properties and chemical durability to the glass composition and the resultant colored glass article. The amount of Al₂O₃ may also be tailored to control the viscosity of the glass composition. Al₂O₃ may be included such that the resultant glass composition has the desired fracture toughness (e.g., greater than or equal to 0.7 M Pa·m^{1/2}). However, if the amount of Al₂O₃ is too high (e.g., greater than 17.5 mol %), the solubility of Cr₂O₃ may decrease, resulting in the formation of Cr-spinel crystals, and the viscosity of the melt may increase, thereby diminishing the formability of the colored glass article.

Accordingly, in embodiments, the glass composition and the resultant colored glass article may comprise greater than or equal to 10 mol % and less than or equal to 17.5 mol % Al₂O₃. In embodiments, the glass composition and the resultant colored glass article may comprise greater than or equal to 12 mol % and less than or equal to 17.25 mol % Al₂O₃. In embodiments, the concentration of Al₂O₃ in the glass composition and the resultant colored glass article may be greater than or equal to 10 mol %, greater than or equal to 12 mol %, greater than or equal to 14 mol %, greater than or equal to 14.5 mol %, greater than or equal to 15 mol %, greater than or equal to 15.5 mol %, or even greater than or equal to 16 mol %. In embodiments, the concentration of Al₂O₃ in the glass composition and the resultant colored glass article may be less than or equal to 17.5 mol %, less than or equal to 17.25 mol %, less than or equal to 17 mol %, or even less than or equal to 16.75 mol %. In embodiments, the concentration of Al₂O₃ in the glass composition and the resultant colored glass article may be greater than or equal to 10 mol % and less than or equal to 17.5 mol %, greater than or equal to 10 mol % and less than or equal to 17.25 mol %, greater than or equal to 10 mol % and less than or equal to 17 mol %, greater than or equal to 10 mol % and less than or equal to 16.75 mol %, greater than or equal to 12 mol % and less than or equal to 17.5 mol %, greater than or equal to 12 mol % and less than or equal to 17.25 mol %, greater than or equal to 12 mol % and less than or equal to 17 mol %, greater than or equal to 12 mol % and less than or equal to 16.75 mol %, greater than or equal to 14 mol % and less than or equal to 17.5 mol %, greater than or equal to 14 mol % and less than or equal to 17.25 mol %, greater than or equal to 14 mol % and less than or equal to 17 mol %, greater than or equal to 14 mol % and less than or equal to 16.75 mol %, greater than or equal to 14.5 mol % and less than or equal to 17.5 mol %, greater than or equal to 14.5 mol % and less than or equal to 17.25 mol %, greater than or equal to 14.5 mol % and less than or equal to 17 mol %, greater than or equal to 14.5 mol % and less than or equal to 16.75 mol %, greater than or equal to 15 mol % and less than or equal to 17.5 mol %, greater than or equal to 15 mol % and less than or equal to 17.25 mol %, greater than or equal to 15 mol % and less than or equal to 17 mol %, greater than or equal to 15 mol % and less than or equal to 16.75 mol %, greater than or equal to 15.5 mol % and less than or equal to 17.5 mol %, greater than or equal to 15.5 mol % and less than or equal to 17.25 mol %, greater than or equal to 15.5 mol % and less than or equal to 17 mol %, greater than or equal to 15.5 mol % and less than or equal to 16.75 mol %, greater than or equal to 16 mol % and less than or equal to 17.5 mol %, greater than or equal to 16 mol % and less than or equal to 17.25 mol %, greater than or equal to 16 mol % and less than or equal to 17 mol %, or even greater than or equal to 16 mol % and less than or equal to 16.75 mol %, or any and all sub-ranges formed from any of these endpoints.

B₂O₃ decreases the melting temperature of the glass composition and may also improve the damage resistance of the resultant colored glass article. In addition, B₂O₃ is added to reduce the formation of non-bridging oxygen, the presence of which may reduce fracture toughness. The concentration of B₂O₃ should be sufficiently high (e.g., greater than or equal to 3 mol %) to improve the formability and increase the fracture toughness of the colored glass article. However, if B₂O₃ is too high (e.g., greater than 10 mol %), the annealing point and strain point may decrease, which increases stress relaxation and reduces overall strength of the colored glass article.

In embodiments, the glass composition and the resultant colored glass article may comprise greater than or equal to 3 mol % and less than or equal to 10 mol % B₂O₃. In embodiments, the glass composition and the resultant colored glass article may comprise greater than or equal to 3.5 mol % and less than or equal to 9 mol % B₂O₃. In embodiments, the concentration of B₂O₃ in the glass composition and the resultant colored glass article may be greater than or equal to 3 mol %, greater than or equal to 3.5 mol %, greater than or equal to 4 mol %, greater than or equal to 4.5 mol %, greater than or equal to 5 mol %, or even greater than or equal to 5.5 mol %. In embodiments, the concentration of B₂O₃ in the glass composition and the resultant colored glass article may be less than or equal to 10 mol %, less than or equal to 9 mol %, less than or equal to 8 mol %, less than or equal to 7.5 mol %, less than or equal to 7 mol %, or even less than or equal to 6.5 mol %. In embodiments, the concentration of B₂O₃ in the glass composition and the resultant colored glass article may be greater than or equal to 3 mol % and less than or equal to 10 mol %, greater than or equal to 3 mol % and less than or equal to 9 mol %, greater than or equal to 3 mol % and less than or equal to 8 mol %, greater than or equal to 3 mol % and less than or equal to 7.5 mol %, greater than or equal to 3 mol % and less than or equal to 7 mol %, greater than or equal to 3 mol % and less than or equal to 6.5 mol %, greater than or equal to 3.5 mol % and less than or equal to 10 mol %, greater than or equal to 3.5 mol % and less than or equal to 9 mol %, greater than or equal to 3.5 mol % and less than or equal to 8 mol %, greater than or equal to 3.5 mol % and less than or equal to 7.5 mol %, greater than or equal to 3.5 mol % and less than or equal to 7 mol %, greater than or equal to 3.5 mol % and less than or equal to 6.5 mol %, greater than or equal to 4 mol % and less than or equal to 10 mol %, greater than or equal to 4 mol % and less than or equal to 9 mol %, greater than or equal to 4 mol % and less than or equal to 8 mol %, greater than or equal to 4 mol % and less than or equal to 7.5 mol %, greater than or equal to 4 mol % and less than or equal to 7 mol %, greater than or equal to 4 mol % and less than or equal to 6.5 mol %, greater than or equal to 4.5 mol % and less than or equal to 10 mol %, greater than or equal to 4.5 mol % and less than or equal to 9 mol %, greater than or equal to 4.5 mol % and less than or equal to 8 mol %, greater than or equal to 4.5 mol % and less than or equal to 7.5 mol %, greater than or equal to 4.5 mol % and less than or equal to 7 mol %, greater than or equal to 4.5 mol % and less than or equal to 6.5 mol %, greater than or equal to 5 mol % and less than or equal to 10 mol %, greater than or equal to 5 mol % and less than or equal to 9 mol %, greater than or equal to 5 mol % and less than or equal to 8 mol %, greater than or equal to 5 mol % and less than or equal to 7.5 mol %, greater than or equal to 5 mol % and less than or equal to 7 mol %, greater than or equal to 5 mol % and less than or equal to 6.5 mol %, greater than or equal to 5.5 mol % and less than or equal to 10 mol %, greater than or equal to 5.5 mol % and less than or equal to 9 mol %, greater than or equal to 5.5 mol % and less than or equal to 8 mol %, greater than or equal to 5.5 mol % and less than or equal to 7.5 mol %, greater than or equal to 5.5 mol % and less than or equal to 7 mol %, or even greater than or equal to 5.5 mol % and less than or equal to 6.5 mol %, or any and all sub-ranges formed from any of these endpoints.

As described hereinabove, the glass compositions and the resultant colored glass articles may contain alkali oxides, such as Li₂O and Na₂O, to enable the ion-exchangeability of the colored glass articles.

Li₂O aids in the ion-exchangeability of the colored glass article and also reduces the softening point of the glass composition, thereby increasing the formability of the colored glass articles. The concentration of Li₂O in the in the glass compositions and resultant colored glass articles should be sufficiently high (e.g., greater than or equal to 8.8 mol %) to achieve the desired maximum central tension (e.g., greater than or equal to 40 M Pa). However, if the amount of Li₂O is too high (e.g., greater than 14 mol %), the liquidus temperature may increase, thereby diminishing the manufacturability of the colored glass article.

In embodiments, the glass composition and the resultant colored glass article may comprise greater than or equal to 8.8 mol % and less than or equal to 14 mol % Li₂O. In embodiments, the glass composition and the resultant colored glass article may comprise greater than or equal to 9 mol % and less than or equal to 13.5 mol % Li₂O. In embodiments, the concentration of Li₂O in the glass composition and the resultant colored glass article may be greater than or equal to 8.8 mol %, greater than or equal to 9 mol %, greater than or equal to 9.2 mol %, greater than or equal to 9.4 mol %, greater than or equal to 9.6 mol %, greater than or equal to 9.8 mol %, or even greater than or equal to 10 mol %. In embodiments, the concentration of Li₂O in the glass composition and the resultant colored glass article may be less than or equal to 14 mol %, less than or equal to 13.5 mol %, less than or equal to 13 mol %, less than or equal to 12.5 mol %, less than or equal to 12 mol %, or even less than or equal to 11.5 mol %. In embodiments, the concentration of Li₂O in the glass composition and the resultant colored glass article may be greater than or equal to 8.8 mol % and less than or equal to 14 mol %, greater than or equal to 8.8 mol % and less than or equal to 13.5 mol %, greater than or equal to 8.8 mol % and less than or equal to 13 mol %, greater than or equal to 8.8 mol % and less than or equal to 12.5 mol %, greater than or equal to 8.8 mol % and less than or equal to 12 mol %, greater than or equal to 8.8 mol % and less than or equal to 11.5 mol %, greater than or equal to 9 mol % and less than or equal to 14 mol %, greater than or equal to 9 mol % and less than or equal to 13.5 mol %, greater than or equal to 9 mol % and less than or equal to 13 mol %, greater than or equal to 9 mol % and less than or equal to 12.5 mol %, greater than or equal to 9 mol % and less than or equal to 12 mol %, greater than or equal to 9 mol % and less than or equal to 11.5 mol %, greater than or equal to 9.2 mol % and less than or equal to 14 mol %, greater than or equal to 9.2 mol % and less than or equal to 13.5 mol %, greater than or equal to 9.2 mol % and less than or equal to 13 mol %, greater than or equal to 9.2 mol % and less than or equal to 12.5 mol %, greater than or equal to 9.2 mol % and less than or equal to 12 mol %, greater than or equal to 9.2 mol % and less than or equal to 11.5 mol %, greater than or equal to 9.4 mol % and less than or equal to 14 mol %, greater than or equal to 9.4 mol % and less than or equal to 13.5 mol %, greater than or equal to 9.4 mol % and less than or equal to 13 mol %, greater than or equal to 9.4 mol % and less than or equal to 12.5 mol %, greater than or equal to 9.4 mol % and less than or equal to 12 mol %, greater than or equal to 9.4 mol % and less than or equal to 11.5 mol %, greater than or equal to 9.6 mol % and less than or equal to 14 mol %, greater than or equal to 9.6 mol % and less than or equal to 13.5 mol %, greater than or equal to 9.6 mol % and less than or equal to 13 mol %, greater than or equal to 9.6 mol % and less than or equal to 12.5 mol %, greater than or equal to 9.6 mol % and less than or equal to 12 mol %, greater than or equal to 9.6 mol % and less than or equal to 11.5 mol %, greater than or equal to 9.8 mol % and less than or equal to 14 mol %, greater than or equal to 9.8 mol % and less than or equal to 13.5 mol %, greater than or equal to 9.8 mol % and less than or equal to 13 mol %, greater than or equal to 9.8 mol % and less than or equal to 12.5 mol %, greater than or equal to 9.8 mol % and less than or equal to 12 mol %, greater than or equal to 9.8 mol % and less than or equal to 11.5 mol %, greater than or equal to 10 mol % and less than or equal to 14 mol %, greater than or equal to 10 mol % and less than or equal to 13.5 mol %, greater than or equal to 10 mol % and less than or equal to 13 mol %, greater than or equal to 10 mol % and less than or equal to 12.5 mol %, greater than or equal to 10 mol % and less than or equal to 12 mol %, or even greater than or equal to 10 mol % and less than or equal to 11.5 mol %, or any and all sub-ranges formed from any of these endpoints.

Na₂O improves diffusivity to reduce ion-exchange time and helps achieve the desired surface compressive stress (e.g., greater than or equal to 300 M Pa). Na₂O also decreases the melting point and improves formability of the colored glass article. However, if too much Na₂O is added to the glass composition, the melting point may be too low. As such, in embodiments, the concentration of Li₂O present in the glass composition and the resultant colored glass article may be greater than the concentration of Na₂O present in the glass composition and the resultant colored glass article.

In embodiments, the glass composition and the resultant colored glass article may comprise greater than or equal to 1.5 mol % and less than or equal to 8 mol % Na₂O. In embodiments, the glass composition and the resultant colored glass article may comprise greater than or equal to 2 mol % and less than or equal to 7.5 mol % Na₂O. In embodiments, the concentration of Na₂O in the glass composition and the resultant colored glass article may be greater than or equal to 1.5 mol %, greater than or equal to 2 mol %, greater than or equal to 2.5 mol %, greater than or equal to 3 mol %, greater than or equal to 3.5 mol %, greater than or equal to 4 mol %, or even greater than or equal to 4.5 mol %. In embodiments, the concentration of Na₂O in the glass composition and the resultant colored glass article may be less than or equal to 8 mol %, less than or equal to 7.5 mol %, less than or equal to 7 mol %, less than or equal to 6.5 mol %, or even less than or equal to 6 mol %. In embodiments, the concentration of Na₂O in the glass composition and the resultant colored glass article may be greater than or equal to 1.5 mol % and less than or equal to 8 mol %, greater than or equal to 1.5 mol % and less than or equal to 7.5 mol %, greater than or equal to 1.5 mol % and less than or equal to 7 mol %, greater than or equal to 1.5 mol % and less than or equal to 6.5 mol %, greater than or equal to 1.5 mol % and less than or equal to 6 mol %, greater than or equal to 2 mol % and less than or equal to 8 mol %, greater than or equal to 2 mol % and less than or equal to 7.5 mol %, greater than or equal to 2 mol % and less than or equal to 7 mol %, greater than or equal to 2 mol % and less than or equal to 6.5 mol %, greater than or equal to 2 mol % and less than or equal to 6 mol %, greater than or equal to 2.5 mol % and less than or equal to 8 mol %, greater than or equal to 2.5 mol % and less than or equal to 7.5 mol %, greater than or equal to 2.5 mol % and less than or equal to 7 mol %, greater than or equal to 2.5 mol % and less than or equal to 6.5 mol %, greater than or equal to 2.5 mol % and less than or equal to 6 mol %, greater than or equal to 3 mol % and less than or equal to 8 mol %, greater than or equal to 3 mol % and less than or equal to 7.5 mol %, greater than or equal to 3 mol % and less than or equal to 7 mol %, greater than or equal to 3 mol % and less than or equal to 6.5 mol %, greater than or equal to 3 mol % and less than or equal to 6 mol %, greater than or equal to 3.5 mol % and less than or equal to 8 mol %, greater than or equal to 3.5 mol % and less than or equal to 7.5 mol %, greater than or equal to 3.5 mol % and less than or equal to 7 mol %, greater than or equal to 3.5 mol % and less than or equal to 6.5 mol %, greater than or equal to 3.5 mol % and less than or equal to 6 mol %, greater than or equal to 4 mol % and less than or equal to 8 mol %, greater than or equal to 4 mol % and less than or equal to 7.5 mol %, greater than or equal to 4 mol % and less than or equal to 7 mol %, greater than or equal to 4 mol % and less than or equal to 6.5 mol %, greater than or equal to 4 mol % and less than or equal to 6 mol %, greater than or equal to 4.5 mol % and less than or equal to 8 mol %, greater than or equal to 4.5 mol % and less than or equal to 7.5 mol %, greater than or equal to 4.5 mol % and less than or equal to 7 mol %, greater than or equal to 4.5 mol % and less than or equal to 6.5 mol %, or even greater than or equal to 4.5 mol % and less than or equal to 6 mol %, or any and all of these sub-ranges formed from any of these endpoints.

The glass compositions and the resultant colored glass articles described herein may further comprise alkali metal oxides other than Li₂O and Na₂O, such as K₂O. K₂O, when included, promotes ion-exchange and may increase the depth of compression and decrease the melting point to improve the formability of the colored glass article. However, adding too much K₂O may cause the surface compressive stress and melting point to be too low. Accordingly, in embodiments, the amount of K₂O added to the glass composition may be limited.

In embodiments, the glass composition and the resultant colored glass article may comprise greater than or equal to 0 mol % and less than or equal to 3 mol % K₂O. In embodiments, the concentration of K₂O in the glass composition and the resultant colored glass article may be greater than or equal to 0 mol %, greater than or equal to 0.2 mol %, or even greater than or equal to 0.4 mol %. In embodiments, the concentration of K₂O in the glass composition and the resultant colored glass article may be less than or equal to 3 mol %, less than or equal to 2.5 mol %, less than or equal to 2 mol %, less than or equal to 1.5 mol %, less than or equal to 1 mol %, less than or equal to 0.75 mol %, or even less than or equal to 0.5 mol %. In embodiments, the concentration of K₂O in the glass composition and the resultant colored glass article may be greater than or equal to 0 mol % and less than or equal to 3 mol %, greater than or equal to 0 mol % and less than or equal to 2.5 mol %, greater than or equal to 0 mol % and less than or equal to 2 mol %, greater than or equal to 0 mol % and less than or equal to 1.5 mol %, greater than or equal to 0 mol % and less than or equal to 1 mol %, greater than or equal to 0 mol % and less than or equal to 0.75 mol %, greater than or equal to 0 mol % and less than or equal to 0.5 mol %, greater than or equal to 0.2 mol % and less than or equal to 3 mol %, greater than or equal to 0.2 mol % and less than or equal to 2.5 mol %, greater than or equal to 0.2 mol % and less than or equal to 2 mol %, greater than or equal to 0.2 mol % and less than or equal to 1.5 mol %, greater than or equal to 0.2 mol % and less than or equal to 1 mol %, greater than or equal to 0.2 mol % and less than or equal to 0.75 mol %, greater than or equal to 0.2 mol % and less than or equal to 0.5 mol %, greater than or equal to 0.4 mol % and less than or equal to 3 mol %, greater than or equal to 0.4 mol % and less than or equal to 2.5 mol %, greater than or equal to 0.4 mol % and less than or equal to 2 mol %, greater than or equal to 0.4 mol % and less than or equal to 1.5 mol %, greater than or equal to 0.4 mol % and less than or equal to 1 mol %, greater than or equal to 0.4 mol % and less than or equal to 0.75 mol %, or even greater than or equal to 0.4 mol % and less than or equal to 0.5 mol %, or any and all sub-ranges formed from any of these endpoints.

The sum of all alkali oxides is expressed herein as R₂O. Specifically, R₂O is the sum (in mol %) of Li₂O, Na₂O, and K₂O present in the glass composition and the resultant colored glass article (i.e., R₂O=Li₂O (mol %)+Na₂O (mol %)+K₂O (mol %). Like B₂O₃, the alkali oxides aid in decreasing the softening point and molding temperature of the glass composition, thereby offsetting the increase in the softening point and molding temperature of the glass composition due to higher amounts of SiO₂ in the glass composition, for example. The softening point and molding temperature may be further reduced by including combinations of alkali oxides (e.g., two or more alkali oxides) in the glass composition, a phenomenon referred to as the “mixed alkali effect.” However, it has been found that if the amount of alkali oxide is too high, the average coefficient of thermal expansion of the glass composition increases to greater than 100×10⁻⁷/° C., which may be undesirable.

In embodiments, the concentration of R₂O in the glass composition and the resultant colored glass article may be greater than or equal to 10.3 mol %, greater than or equal to 11 mol %, greater than or equal to 12 mol %, greater than or equal to 13 mol %, or even greater than or equal to 14 mol. In embodiments, the concentration of R₂O in the glass composition and the resultant colored glass article may be less than or equal to 22 mol %, less than or equal to 21 mol %, less than or equal to 20 mol %, less than or equal to 19 mol %, or even less than or equal to 18 mol %. In embodiments, the concentration of R₂O in the glass composition and the resultant colored glass article may be greater than or equal to 10.3 mol % and less than or equal to 22 mol %, greater than or equal to 10.3 mol % and less than or equal to 21 mol %, greater than or equal to 10.3 mol % and less than or equal to 20 mol %, greater than or equal to 10.3 mol % and less than or equal to 19 mol %, greater than or equal to 10.3 mol % and less than or equal to 18 mol %, greater than or equal to 11 mol % and less than or equal to 22 mol %, greater than or equal to 11 mol % and less than or equal to 21 mol %, greater than or equal to 11 mol % and less than or equal to 20 mol %, greater than or equal to 11 mol % and less than or equal to 19 mol %, greater than or equal to 11 mol % and less than or equal to 18 mol %, greater than or equal to 12 mol % and less than or equal to 22 mol %, greater than or equal to 12 mol % and less than or equal to 21 mol %, greater than or equal to 12 mol % and less than or equal to 20 mol %, greater than or equal to 12 mol % and less than or equal to 19 mol %, greater than or equal to 12 mol % and less than or equal to 18 mol %, greater than or equal to 13 mol % and less than or equal to 22 mol %, greater than or equal to 13 mol % and less than or equal to 21 mol %, greater than or equal to 13 mol % and less than or equal to 20 mol %, greater than or equal to 13 mol % and less than or equal to 19 mol %, greater than or equal to 13 mol % and less than or equal to 18 mol %, greater than or equal to 14 mol % and less than or equal to 22 mol %, greater than or equal to 14 mol % and less than or equal to 21 mol %, greater than or equal to 14 mol % and less than or equal to 20 mol %, greater than or equal to 14 mol % and less than or equal to 19 mol %, or even greater than or equal to 14 mol % and less than or equal to 18 mol %, or any and all sub-ranges formed from any of these endpoints.

The glass compositions and the resultant colored glass articles described herein may further comprise MgO. MgO lowers the viscosity of the glass compositions, which enhances the formability, the strain point, and the Young's modulus, and may improve the ion-exchangeability. However, when too much MgO is added to the glass composition, the diffusivity of sodium and potassium ions in the glass composition decreases which, in turn, adversely impacts the ion-exchange performance (i.e., the ability to ion-exchange) of the resultant colored glass article.

In embodiments, the glass composition and the resultant colored glass article may comprise greater than or equal to 0 mol % and less than or equal to 4.5 mol % MgO. In embodiments, the concentration of MgO in the glass composition may be greater than or equal to 0 mol %, greater than or equal to 0.5 mol %, greater than or equal to 1 mol %, greater than or equal to 1.5 mol %, or even greater than or equal to 2 mol %. In embodiments, the concentration of MgO in the glass composition may be less than or equal to 4.5 mol %, less than or equal to 4 mol %, less than or equal to 3.5 mol %, or even less than or equal to 3 mol %. In embodiments, the concentration of MgO in the glass composition may be greater than or equal to 0 mol % and less than or equal to 4.5 mol %, greater than or equal to 0 mol % and less than or equal to 4 mol %, greater than or equal to 0 mol % and less than or equal to 3.5 mol %, greater than or equal to 0 mol % and less than or equal to 3 mol %, greater than or equal to 0.5 mol % and less than or equal to 4.5 mol %, greater than or equal to 0.5 mol % and less than or equal to 4 mol %, greater than or equal to 0.5 mol % and less than or equal to 3.5 mol %, greater than or equal to 0.5 mol % and less than or equal to 3 mol %, greater than or equal to 1 mol % and less than or equal to 4.5 mol %, greater than or equal to 1 mol % and less than or equal to 4 mol %, greater than or equal to 1 mol % and less than or equal to 3.5 mol %, greater than or equal to 1 mol % and less than or equal to 3 mol %, greater than or equal to 1.5 mol % and less than or equal to 4.5 mol %, greater than or equal to 1.5 mol % and less than or equal to 4 mol %, greater than or equal to 1.5 mol % and less than or equal to 3.5 mol %, greater than or equal to 1.5 mol % and less than or equal to 3 mol %, greater than or equal to 2 mol % and less than or equal to 4.5 mol %, greater than or equal to 2 mol % and less than or equal to 4 mol %, greater than or equal to 2 mol % and less than or equal to 3.5 mol %, or even greater than or equal to 2 mol % and less than or equal to 3 mol %, or any and all sub-ranges formed from any of these endpoints.

The glass compositions and the resultant colored glass articles described herein may further comprise ZnO. ZnO lowers the viscosity of the glass compositions, which enhances the formability, the strain point, and the Young's modulus, and may improve the ion-exchangeability. However, when too much ZnO is added to the glass composition, the diffusivity of sodium and potassium ions in the glass composition decreases which, in turn, adversely impacts the ion-exchange performance (i.e., the ability to ion-exchange) of the resultant colored glass article.

In embodiments, the glass composition and the resultant colored glass article may comprise greater than or equal to 0 mol % and less than or equal to 4.5 mol % ZnO. In embodiments, the concentration of ZnO in the glass composition may be greater than or equal to 0 mol %, greater than or equal to 0.5 mol %, greater than or equal to 1 mol %, greater than or equal to 1.5 mol %, or even greater than or equal to 2 mol %. In embodiments, the concentration of ZnO in the glass composition may be less than or equal to 4.5 mol %, less than or equal to 4 mol %, less than or equal to 3.5 mol %, or even less than or equal to 3 mol %. In embodiments, the concentration of ZnO in the glass composition may be greater than or equal to 0 mol % and less than or equal to 4.5 mol %, greater than or equal to 0 mol % and less than or equal to 4 mol %, greater than or equal to 0 mol % and less than or equal to 3.5 mol %, greater than or equal to 0 mol % and less than or equal to 3 mol %, greater than or equal to 0.5 mol % and less than or equal to 4.5 mol %, greater than or equal to 0.5 mol % and less than or equal to 4 mol %, greater than or equal to 0.5 mol % and less than or equal to 3.5 mol %, greater than or equal to 0.5 mol % and less than or equal to 3 mol %, greater than or equal to 1 mol % and less than or equal to 4.5 mol %, greater than or equal to 1 mol % and less than or equal to 4 mol %, greater than or equal to 1 mol % and less than or equal to 3.5 mol %, greater than or equal to 1 mol % and less than or equal to 3 mol %, greater than or equal to 1.5 mol % and less than or equal to 4.5 mol %, greater than or equal to 1.5 mol % and less than or equal to 4 mol %, greater than or equal to 1.5 mol % and less than or equal to 3.5 mol %, greater than or equal to 1.5 mol % and less than or equal to 3 mol %, greater than or equal to 2 mol % and less than or equal to 4.5 mol %, greater than or equal to 2 mol % and less than or equal to 4 mol %, greater than or equal to 2 mol % and less than or equal to 3.5 mol %, or even greater than or equal to 2 mol % and less than or equal to 3 mol %, or any and all sub-ranges formed from any of these endpoints.

In embodiments, the sum of MgO and ZnO present in the glass composition and the resultant colored glass article (i.e., MgO (mol %)+ZnO (mol %)) may be greater than or equal to 0 mol % and less than or equal to 4.5 mol % to avoid the formation of Cr-spinel crystals, thereby increasing Cr₂O₃ solubility and expanding the color gamut that may be achieved by the resultant colored glass articles.

In embodiments, the sum of MgO and ZnO in the glass compositions and the resultant colored glass article may be greater than or equal to 0 mol % and less than or equal to 1 mol %. In embodiments, the sum of MgO and ZnO in the glass composition and the resultant colored glass article may be greater than or equal to 1 mol % and less than or equal to 4.5 mol %. In embodiments, the sum of MgO and ZnO in the glass composition and the resultant colored glass article may be greater than or equal to 0 mol %, greater than or equal to 0.5 mol %, greater than or equal to 1 mol %, greater than or equal to 1.5 mol %, greater than or equal to 2 mol %, greater than or equal to 2.5 mol %, or even greater than or equal to 3 mol %. In embodiments, the sum of MgO and ZnO in the glass composition and the resultant colored glass article may be less than or equal to 4.5 mol %, less than or equal to 4.25 mol %, or even less than or equal to 4 mol %. In embodiments, the sum of MgO and ZnO in the glass composition and the resultant colored glass article may be greater than or equal to 0 mol % and less than or equal to 4.5 mol %, greater than or equal to 0 mol % and less than or equal to 4.25 mol %, greater than or equal to 0 mol % and less than or equal to 4 mol %, greater than or equal to 0.5 mol % and less than or equal to 4.5 mol %, greater than or equal to 0.5 mol % and less than or equal to 4.25 mol %, greater than or equal to 0.5 mol % and less than or equal to 4 mol %, greater than or equal to 1 mol % and less than or equal to 4.5 mol %, greater than or equal to 1 mol % and less than or equal to 4.25 mol %, greater than or equal to 1 mol % and less than or equal to 4 mol %, greater than or equal to 1.5 mol % and less than or equal to 4.5 mol %, greater than or equal to 1.5 mol % and less than or equal to 4.25 mol %, greater than or equal to 1.5 mol % and less than or equal to 4 mol %, greater than or equal to 2 mol % and less than or equal to 4.5 mol %, greater than or equal to 2 mol % and less than or equal to 4.25 mol %, greater than or equal to 2 mol % and less than or equal to 4 mol %, greater than or equal to 2.5 mol % and less than or equal to 4.5 mol %, greater than or equal to 2.5 mol % and less than or equal to 4.25 mol %, greater than or equal to 2.5 mol % and less than or equal to 4 mol %, greater than or equal to 3 mol % and less than or equal to 4.5 mol %, greater than or equal to 3 mol % and less than or equal to 4.25 mol %, or even greater than or equal to 3 mol % and less than or equal to 4 mol %, or any and all sub-ranges formed from any of these endpoints.

In embodiments, the sum of Al₂O₃, MgO, and ZnO present in the glass composition and the resultant colored glass article (i.e., Al₂O₃ (mol %)+MgO (mol %)+ZnO (mol %)) may be greater than or equal to 12 mol % and less than or equal to 22 mol % to avoid the formation of Cr-spinel crystals, thereby increasing Cr₂O₃ solubility and expanding the color gamut that may be achieved by the resultant colored glass articles.

In embodiments, the sum of Al₂O₃, MgO, and ZnO in the glass composition and the resultant colored glass article may be greater than or equal to 13 mol % and less than or equal to 21.5 mol %. In embodiments, the sum of Al₂O₃, MgO, and ZnO in the glass composition and the resultant colored glass article may be greater than or equal to 12 mol %, greater than or equal to 13 mol %, greater than or equal to 14 mol %, greater than or equal to 15 mol %, or even greater than or equal to 16 mol %. In embodiments, the sum of Al₂O₃, MgO, and ZnO in the glass composition and the resultant colored glass article may be less than or equal to 22 mol %, less than or equal to 21.5 mol %, less than or equal to 21 mol %, less than or equal to 20.5 mol %, or even less than or equal to 20 mol %. In embodiments, the sum of Al₂O₃, MgO, and ZnO in the glass composition and the resultant colored glass article may be greater than or equal to 12 mol % and less than or equal to 22 mol %, greater than or equal to 12 mol % and less than or equal to 21.5 mol %, greater than or equal to 12 mol % and less than or equal to 21 mol %, greater than or equal to 12 mol % and less than or equal to 20.5 mol %, greater than or equal to 12 mol % and less than or equal to 20 mol %, greater than or equal to 13 mol % and less than or equal to 22 mol %, greater than or equal to 13 mol % and less than or equal to 21.5 mol %, greater than or equal to 13 mol % and less than or equal to 21 mol %, greater than or equal to 13 mol % and less than or equal to 20.5 mol %, greater than or equal to 13 mol % and less than or equal to 20 mol %, greater than or equal to 14 mol % and less than or equal to 22 mol %, greater than or equal to 14 mol % and less than or equal to 21.5 mol %, greater than or equal to 14 mol % and less than or equal to 21 mol %, greater than or equal to 14 mol % and less than or equal to 20.5 mol %, greater than or equal to 15 mol % and less than or equal to 20 mol %, greater than or equal to 15 mol % and less than or equal to 22 mol %, greater than or equal to 15 mol % and less than or equal to 21.5 mol %, greater than or equal to 15 mol % and less than or equal to 21 mol %, greater than or equal to 15 mol % and less than or equal to 20.5 mol %, greater than or equal to 15 mol % and less than or equal to 20 mol %, greater than or equal to 16 mol % and less than or equal to 22 mol %, greater than or equal to 16 mol % and less than or equal to 21.5 mol %, greater than or equal to 16 mol % and less than or equal to 21 mol %, greater than or equal to 16 mol % and less than or equal to 20.5 mol %, or even greater than or equal to 16 mol % and less than or equal to 20 mol %, or any and all sub-ranges formed from any of these endpoints.

The glass compositions and the resultant colored glass articles described herein may further comprise CaO. CaO lowers the viscosity of a glass composition, which enhances the formability, the strain point and the Young's modulus, and may improve the ion-exchangeability. However, when too much CaO is added to the glass composition, the diffusivity of sodium and potassium ions in the glass composition decreases which, in turn, adversely impacts the ion-exchange performance (i.e., the ability to ion-exchange) of the resultant glass.

In embodiments, the glass composition and the resultant colored glass article may comprise greater than or equal to 0 mol % and less than or equal to 2 mol % CaO. In embodiments, the concentration of CaO in the glass composition and the resultant colored glass article may be greater than or equal to 0 mol %, greater than or equal to 0.25 mol %, greater than or equal to 0.5 mol %, or even greater than or equal to 0.75 mol %. In embodiments, the concentration of CaO in the glass composition and the resultant colored glass article may be less than or equal to 2 mol %, less than or equal to 1.75 mol %, less than or equal to 1.5 mol %, less than or equal to 1.25 mol %, or even less than or equal to 1 mol %. In embodiments, the concentration of CaO in the glass composition and the resultant colored glass article may be greater than or equal to 0 mol % and less than or equal to 2 mol %, greater than or equal to 0 mol % and less than or equal to 1.75 mol %, greater than or equal to 0 mol % and less than or equal to 1.5 mol %, greater than or equal to 0 mol % and less than or equal to 1.25 mol %, greater than or equal to 0 mol % and less than or equal to 1 mol %, greater than or equal to 0.25 mol % and less than or equal to 2 mol %, greater than or equal to 0.25 mol % and less than or equal to 1.75 mol %, greater than or equal to 0.25 mol % and less than or equal to 1.5 mol %, greater than or equal to 0.25 mol % and less than or equal to 1.25 mol %, greater than or equal to 0.25 mol % and less than or equal to 1 mol %, greater than or equal to 0.5 mol % and less than or equal to 2 mol %, greater than or equal to 0.5 mol % and less than or equal to 1.75 mol %, greater than or equal to 0.5 mol % and less than or equal to 1.5 mol %, greater than or equal to 0.5 mol % and less than or equal to 1.25 mol %, greater than or equal to 0.5 mol % and less than or equal to 1 mol %, greater than or equal to 0.75 mol % and less than or equal to 2 mol %, greater than or equal to 0.75 mol % and less than or equal to 1.75 mol %, greater than or equal to 0.75 mol % and less than or equal to 1.5 mol %, greater than or equal to 0.75 mol % and less than or equal to 1.25 mol %, or even greater than or equal to 0.75 mol % and less than or equal to 1 mol %, or any and all sub-ranges formed from any of these endpoints.

The sum of all divalent cation oxides is expressed herein as RO. Specifically, RO is the sum (in mol %) of MgO, ZnO, and CaO (i.e. RO=MgO (mol %)+ZnO (mol %)+Cao (mol %)). In embodiments, the concentration of RO in the glass composition and the resultant colored glass article may be greater than or equal to 0 mol %, greater than or equal to 0.5 mol %, greater than or equal to 1 mol %, greater than or equal to 1.5 mol %, greater than or equal to 2 mol %, or even greater than or equal to 2.5 mol %. In embodiments, the concentration of RO in the glass composition and the resultant colored glass article may be less than or equal to 5 mol %, less than or equal to 4.5 mol %, less than or equal to 4 mol %, or even less than or equal to 3.5 mol %. In embodiments, the concentration of RO in the glass composition and the resultant colored glass article may be greater than or equal to 0 mol % and less than or equal to 5 mol %, greater than or equal to 0 mol % and less than or equal to 4.5 mol %, greater than or equal to 0 mol % and less than or equal to 4 mol %, greater than or equal to 0 mol % and less than or equal to 3.5 mol %, greater than or equal to 0.5 mol % and less than or equal to 5 mol %, greater than or equal to 0.5 mol % and less than or equal to 4.5 mol %, greater than or equal to 0.5 mol % and less than or equal to 4 mol %, greater than or equal to 0.5 mol % and less than or equal to 3.5 mol %, greater than or equal to 1 mol % and less than or equal to 5 mol %, greater than or equal to 1 mol % and less than or equal to 4.5 mol %, greater than or equal to 1 mol % and less than or equal to 4 mol %, greater than or equal to 1 mol % and less than or equal to 3.5 mol %, greater than or equal to 1.5 mol % and less than or equal to 5 mol %, greater than or equal to 1.5 mol % and less than or equal to 4.5 mol %, greater than or equal to 1.5 mol % and less than or equal to 4 mol %, greater than or equal to 1.5 mol % and less than or equal to 3.5 mol %, greater than or equal to 2 mol % and less than or equal to 5 mol %, greater than or equal to 2 mol % and less than or equal to 4.5 mol %, greater than or equal to 2 mol % and less than or equal to 4 mol %, greater than or equal to 2 mol % and less than or equal to 3.5 mol %, greater than or equal to 2.5 mol % and less than or equal to 5 mol %, greater than or equal to 2.5 mol % and less than or equal to 4.5 mol %, greater than or equal to 2.5 mol % and less than or equal to 4 mol %, or even greater than or equal to 2.5 mol % and less than or equal to 3.5 mol %, or any and all sub-ranges formed from any of these endpoints.

In embodiments, the glass compositions and the resultant colored glass articles are per-alkali (i.e., R₂O (mol %)+RO (mol %)−Al₂O₃ (mol %) is greater than or equal to 0.5 mol %) to increase the solubility of Cr₂O₃ and avoid Cr-spinel crystal formation. However, when the glass composition has an excessive amount of alkali after charge balancing Al₂O₃, the alkali may form non-bridging oxygen around SiO₂, which degrades fracture toughness. Accordingly, R₂O+RO−Al₂O₃ in the glass composition and the resultant colored glass article may be limited (e.g., less than or equal to 6 mol %) to prevent a reduction in fracture toughness.

In embodiments, R₂O+RO−Al₂O₃ in the glass composition and the resultant colored glass article may be greater than or equal to 0.5 mol % and less than or equal to 6 mol %. In embodiments, R₂O+RO−Al₂O₃ in the glass composition and the resultant colored glass article may be greater than or equal to 1 mol % and less than or equal to 5.5 mol %. %. In embodiments, R₂O+RO−Al₂O₃ in the glass composition and the colored resultant glass article may be greater than or equal to 0.5 mol %, greater than or equal to 1 mol %, greater than or equal to 1.5 mol %, or even greater than or equal to 2 mol %. In embodiments, R 20+RO-Al₂O₃ in the glass composition and the resultant colored glass article may be less than or equal to 6 mol %, less than or equal to 5.5 mol %, less than or equal to 5 mol %, less than or equal to 4.5 mol %, less than or equal to 4 mol %, less than or equal to 3.5 mol %, or even less than or equal to 3 mol %. In embodiments, R₂O+RO−Al₂O₃ in the glass composition and the resultant colored glass article may be greater than or equal to 0.5 mol % and less than or equal to 6 mol %, greater than or equal to 0.5 mol % and less than or equal to 5.5 mol %, greater than or equal to 0.5 mol % and less than or equal to 5 mol %, greater than or equal to 0.5 mol % and less than or equal to 4.5 mol %, greater than or equal to 0.5 mol % and less than or equal to 4 mol %, greater than or equal to 0.5 mol % and less than or equal to 3.5 mol %, greater than or equal to 0.5 mol % and less than or equal to 3 mol %, greater than or equal to 1 mol % and less than or equal to 6 mol %, greater than or equal to 1 mol % and less than or equal to 5.5 mol %, greater than or equal to 1 mol % and less than or equal to 5 mol %, greater than or equal to 1 mol % and less than or equal to 4.5 mol %, greater than or equal to 1 mol % and less than or equal to 4 mol %, greater than or equal to 1 mol % and less than or equal to 3.5 mol %, greater than or equal to 1 mol % and less than or equal to 3 mol %, greater than or equal to 1.5 mol % and less than or equal to 6 mol %, greater than or equal to 1.5 mol % and less than or equal to 5.5 mol %, greater than or equal to 1.5 mol % and less than or equal to 5 mol %, greater than or equal to 1.5 mol % and less than or equal to 4.5 mol %, greater than or equal to 1.5 mol % and less than or equal to 4 mol %, greater than or equal to 1.5 mol % and less than or equal to 3.5 mol %, greater than or equal to 1.5 mol % and less than or equal to 3 mol %, greater than or equal to 2 mol % and less than or equal to 6 mol %, greater than or equal to 2 mol % and less than or equal to 5.5 mol %, greater than or equal to 2 mol % and less than or equal to 5 mol %, greater than or equal to 2 mol % and less than or equal to 4.5 mol %, greater than or equal to 2 mol % and less than or equal to 4 mol %, greater than or equal to 2 mol % and less than or equal to 3.5 mol %, or even greater than or equal to 2 mol % and less than or equal to 3 mol %, or any and all sub-ranges formed from any of these endpoints.

In embodiments, the glass compositions and the resultant colored glass articles described herein may satisfy only one of the following conditions and achieve the desired color: (1) less than or equal to 17.5 mol % Al₂O₃ and/or R₂O+RO−Al₂O₃ greater than or equal to 0.5 mol %; (2) Al₂O₃+MgO+ZnO less than or equal to 22 mol %; and (3) MgO+ZnO less than or equal to 4.5 mol %.

The glass compositions and the resultant colored glass articles described herein further comprise Cr₂O₃ as a colorant to achieve the desired color. As described herein, the glass compositions and the resultant colored glass articles described herein improve the solubility of Cr₂O₃, thereby expanding the color gamut achievable by the resultant colored glass articles.

In embodiments, the glass composition and the resultant colored glass article may comprise greater than 0 mol % and less than or equal to 2 mol % Cr₂O₃. In embodiments, the glass composition and the resultant colored glass article may comprise greater than 0.001 mol % and less than or equal to 1.5 mol % Cr₂O₃. In embodiments, the concentration of Cr₂O₃ in the glass composition and the resultant colored glass article may be greater than 0 mol %, greater than or equal to 0.001 mol %, greater than or equal to 0.005 mol %, greater than or equal to 0.01 mol %, or even greater than or equal to 0.05 mol %. In embodiments, the concentration of Cr₂O₃ in the glass composition and the resultant colored glass article may be less than or equal to 2 mol %, less than or equal to 1.5 mol %, less than or equal to 1 mol %, less than or equal to 0.5 mol %, or even less than or equal to 0.1 mol %. In embodiments, the concentration of Cr₂O₃ in the glass composition and the resultant colored glass article may be greater than 0 mol % and less than or equal to 2 mol %, greater than 0 mol % and less than or equal to 1.5 mol %, greater than 0 mol % and less than or equal to 1 mol %, greater than 0 mol % and less than or equal to 0.5 mol %, greater than 0 mol % and less than or equal to 0.1 mol %, greater than or equal to 0.001 mol % and less than or equal to 2 mol %, greater than or equal to 0.001 mol % and less than or equal to 1.5 mol %, greater than or equal to 0.001 mol % and less than or equal to 1 mol %, greater than or equal to 0.001 mol % and less than or equal to 0.5 mol %, greater than or equal to 0.001 mol % and less than or equal to 0.1 mol %, greater than or equal to 0.005 mol % and less than or equal to 2 mol %, greater than or equal to 0.005 mol % and less than or equal to 1.5 mol %, greater than or equal to 0.005 mol % and less than or equal to 1 mol %, greater than or equal to 0.005 mol % and less than or equal to 0.5 mol %, greater than or equal to 0.005 mol % and less than or equal to 0.1 mol %, greater than or equal to 0.01 mol % and less than or equal to 2 mol %, greater than or equal to 0.01 mol % and less than or equal to 1.5 mol %, greater than or equal to 0.01 mol % and less than or equal to 1 mol %, greater than or equal to 0.01 mol % and less than or equal to 0.5 mol %, greater than or equal to 0.01 mol % and less than or equal to 0.1 mol %, greater than or equal to 0.05 mol % and less than or equal to 2 mol %, greater than or equal to 0.05 mol % and less than or equal to 1.5 mol %, greater than or equal to 0.05 mol % and less than or equal to 1 mol %, greater than or equal to 0.05 mol % and less than or equal to 0.5 mol %, or even greater than or equal to 0.05 mol % and less than or equal to 0.1 mol %, or any and all sub-ranges formed from any of these endpoints.

Different color gamuts may be achieved by including other colorants in addition to Cr₂O₃. Accordingly, in embodiments, the glass composition and resultant colored glass article may comprise NiO, Co₃O₄, CuO, or combinations thereof.

In embodiments, the glass composition and the resultant colored glass article may comprise greater than or equal to 0 mol % and less than or equal to 4 mol % NiO. In embodiments, the concentration of NiO in the glass composition and the resultant colored glass article may be greater than or equal to 0 mol %, greater than or equal to 0.01 mol %, or even greater than or equal to 0.05 mol %. In embodiments, the concentration of NiO in the glass composition and the resultant colored glass article may be less than or equal to 4 mol %, less than or equal to 3 mol %, less than or equal to 2 mol %, less than or equal to 1 mol %, less than or equal to 0.5 mol %, less than or equal to 0.25 mol %, or even less than or equal to 0.1 mol %. In embodiments, the concentration of NiO in the glass composition and the resultant colored glass article may be greater than or equal to 0 mol % and less than or equal to 4 mol %, greater than or equal to 0 mol % and less than or equal to 3 mol %, greater than or equal to 0 mol % and less than or equal to 2 mol %, greater than or equal to 0 mol % and less than or equal to 1 mol %, greater than or equal to 0 mol % and less than or equal to 0.5 mol %, greater than or equal to 0 mol % and less than or equal to 0.25 mol %, greater than or equal to 0 mol % and less than or equal to 0.1 mol %, greater than or equal to 0.01 mol % and less than or equal to 4 mol %, greater than or equal to 0.01 mol % and less than or equal to 3 mol %, greater than or equal to 0.01 mol % and less than or equal to 2 mol %, greater than or equal to 0.01 mol % and less than or equal to 1 mol %, greater than or equal to 0.01 mol % and less than or equal to 0.5 mol %, greater than or equal to 0.01 mol % and less than or equal to 0.25 mol %, greater than or equal to 0.01 mol % and less than or equal to 0.1 mol %, greater than or equal to 0.05 mol % and less than or equal to 4 mol %, greater than or equal to 0.05 mol % and less than or equal to 3 mol %, greater than or equal to 0.05 mol % and less than or equal to 2 mol %, greater than or equal to 0.05 mol % and less than or equal to 1 mol %, greater than or equal to 0.05 mol % and less than or equal to 0.5 mol %, greater than or equal to 0.05 mol % and less than or equal to 0.25 mol %, or even greater than or equal to 0.05 mol % and less than or equal to 0.1 mol %, or any and all sub-ranges formed between any of these endpoints.

In embodiments, the glass composition and the resultant colored glass article may comprise greater than or equal to 0 mol % and less than or equal to 2 mol % Co₃O₄. In embodiments, the concentration of Co₃O₄ in the glass composition and the resultant colored glass article may be greater than or equal to 0 mol %, greater than or equal to 0.001 mol %, greater than or equal to 0.005 mol %, or even greater than or equal to 0.01 mol %. In embodiments, the concentration of Co₃O₄ in the glass composition and the resultant colored glass article may be less than or equal to 2 mol %, less than or equal to 1.5 mol %, less than or equal to 1 mol %, less than or equal to 0.5 mol %, less than or equal to 0.1 mol %, or even less than or equal to 0.05 mol %. In embodiments, the concentration of Co₃O₄ in the glass composition and the resultant colored glass article may greater than or equal to 0 mol % and less than or equal to 2 mol %, greater than or equal to 0 mol % and less than or equal to 1.5 mol %, greater than or equal to 0 mol % and less than or equal to 1 mol %, greater than or equal to 0 mol % and less than or equal to 0.5 mol %, greater than or equal to 0 mol % and less than or equal to 0.1 mol %, greater than or equal to 0 mol % and less than or equal to 0.05 mol %, greater than or equal to 0.001 mol % and less than or equal to 2 mol %, greater than or equal to 0.001 mol % and less than or equal to 1.5 mol %, greater than or equal to 0.001 mol % and less than or equal to 1 mol %, greater than or equal to 0.001 mol % and less than or equal to 0.5 mol %, greater than or equal to 0.001 mol % and less than or equal to 0.1 mol %, greater than or equal to 0.001 mol % and less than or equal to 0.05 mol %, greater than or equal to 0.005 mol % and less than or equal to 2 mol %, greater than or equal to 0.005 mol % and less than or equal to 1.5 mol %, greater than or equal to 0.005 mol % and less than or equal to 1 mol %, greater than or equal to 0.005 mol % and less than or equal to 0.5 mol %, greater than or equal to 0.005 mol % and less than or equal to 0.1 mol %, greater than or equal to 0.005 mol % and less than or equal to 0.05 mol %, greater than or equal to 0.01 mol % and less than or equal to 2 mol %, greater than or equal to 0.01 mol % and less than or equal to 1.5 mol %, greater than or equal to 0.01 mol % and less than or equal to 1 mol %, greater than or equal to 0.01 mol % and less than or equal to 0.5 mol %, greater than or equal to 0.01 mol % and less than or equal to 0.1 mol %, or even greater than or equal to 0.01 mol % and less than or equal to 0.05 mol %, or any and all sub-ranges formed from any of these endpoints.

In embodiments, the glass composition and the resultant colored glass article may comprise greater than or 0 mol % and less than or equal to 20 mol % CuO. In embodiments, the concentration of CuO in the glass composition and the resultant colored glass article may be greater than or equal 0 mol %, greater than or equal to 0.05 mol %, greater than or equal to 0.1 mol %, greater than or equal to 0.5 mol %, or even greater than or equal to 1 mol %. In embodiments, the concentration of CuO in the glass composition and the resultant colored glass article may be less than or equal to 20 mol %, less than or equal to 15 mol %, less than or equal to 10 mol %, less than or equal to 5 mol %, less than or equal to 4 mol %, less than or equal to 3 mol %, or even less than or equal to 2 mol %. In embodiments, the concentration of CuO in the glass composition and the resultant colored glass article may be greater than or equal to 0 mol % and less than or equal to 20 mol %, greater than or equal to 0 mol % and less than or equal to 15 mol %, greater than or equal to 0 mol % and less than or equal to 10 mol %, greater than or equal to 0 mol % and less than or equal to 5 mol %, greater than or equal to 0 mol % and less than or equal to 4 mol %, greater than or equal to 0 mol % and less than or equal to 3 mol %, greater than or equal to 0 mol % and less than or equal to 2 mol, greater than or equal to 0.05 mol % and less than or equal to 20 mol %, greater than or equal to 0.05 mol % and less than or equal to 15 mol %, greater than or equal to 0.05 mol % and less than or equal to 10 mol %, greater than or equal to 0.05 mol % and less than or equal to 5 mol %, greater than or equal to 0.05 mol % and less than or equal to 4 mol %, greater than or equal to 0.05 mol % and less than or equal to 3 mol %, greater than or equal to 0.05 mol % and less than or equal to 2 mol %, greater than or equal to 0.1 mol % and less than or equal to 20 mol %, greater than or equal to 0.1 mol % and less than or equal to 15 mol %, greater than or equal to 0.1 mol % and less than or equal to 10 mol %, greater than or equal to 0.1 mol % and less than or equal to 5 mol %, greater than or equal to 0.1 mol % and less than or equal to 4 mol %, greater than or equal to 0.1 mol % and less than or equal to 3 mol %, greater than or equal to 0.1 mol % and less than or equal to 2 mol %, greater than or equal to 0.5 mol % and less than or equal to 20 mol %, greater than or equal to 0.5 mol % and less than or equal to 15 mol %, greater than or equal to 0.5 mol % and less than or equal to 10 mol %, greater than or equal to 0.5 mol % and less than or equal to 5 mol %, greater than or equal to 0.5 mol % and less than or equal to 4 mol %, greater than or equal to 0.5 mol % and less than or equal to 3 mol %, greater than or equal to 0.5 mol % and less than or equal to 2 mol %, greater than or equal to 1 mol % and less than or equal to 20 mol %, greater than or equal to 1 mol % and less than or equal to 15 mol %, greater than or equal to 1 mol % and less than or equal to 10 mol %, greater than or equal to 1 mol % and less than or equal to 5 mol %, greater than or equal to 1 mol % and less than or equal to 4 mol %, greater than or equal to 1 mol % and less than or equal to 3 mol %, or even greater than or equal to 1 mol % and less than or equal to 2 mol %, or any and all sub-ranges formed from any of these endpoints.

In embodiments, the glass compositions and the resultant colored glass articles described herein may further include tramp materials such as TiO₂, MnO, MoO₃, WO₃, Y₂O₃, CdO, As₂O₃, Sb₂O₃, sulfur-based compounds, such as sulfates, halogens, or combinations thereof. In embodiments, antimicrobial components, chemical fining agents, or other additional components may be included in the glass compositions and the resultant colored glass articles.

In embodiments, a liquidus temperature of a glass composition may be greater than or equal to 1000° C., greater than or equal to 1050° C., or even greater than or equal to 1100° C. In embodiments, a liquidus temperature of the precursor glass composition may be less than or equal to 1400° C., less than or equal to 1350° C. or even less than or equal to 1300° C. In embodiments, a liquidus temperature of the precursor glass composition may be greater than or equal to 1000° C. and less than or equal to 1400° C., greater than or equal to 1000° C. and less than or equal to 1350° C., greater than or equal to 1000° C. and less than or equal to 1300° C., greater than or equal to 1050° C. and less than or equal to 1400° C., greater than or equal to 1050° C. and less than or equal to 1350° C., greater than or equal to 1000° C. and less than or equal to 1300° C., greater than or equal to 1100° C. and less than or equal to 1400° C., greater than or equal to 1100° C. and less than or equal to 1350° C., or even greater than or equal to 1100° C. and less than or equal to 1300° C., or any and all sub-ranges formed from any of these endpoints.

The colored glass articles formed from the glass compositions described herein may be any suitable thickness, which may vary depending on the particular application of the colored glass article. In embodiments, the glass sheet embodiments may have a thickness greater than or equal to 250 μm and less than or equal to 6 mm, greater than or equal to 250 μm and less than or equal to 4 mm, greater than or equal to 250 μm and less than or equal to 2 mm, greater than or equal to 250 μm and less than or equal to 1 mm, greater than or equal to 250 μm and less than or equal to 750 μm, greater than or equal to 250 μm and less than or equal to 500 μm, greater than or equal to 500 μm and less than or equal to 6 mm, greater than or equal to 500 μm and less than or equal to 4 mm, greater than or equal to 500 μm and less than or equal to 2 mm, greater than or equal to 500 μm and less than or equal to 1 mm, greater than or equal to 500 μm and less than or equal to 750 μm, greater than or equal to 750 μm and less than or equal to 6 mm, greater than or equal to 750 μm and less than or equal to 4 mm, greater than or equal to 750 μm and less than or equal to 2 mm, greater than or equal to 750 μm and less than or equal to 1 mm, greater than or equal to 1 mm and less than or equal to 6 mm, greater than or equal to 1 mm and less than or equal to 4 mm, greater than or equal to 1 mm and less than or equal to 2 mm, greater than or equal to 2 mm and less than or equal to 6 mm, greater than or equal to 2 mm and less than or equal to 4 mm, or even greater than or equal to 4 mm and less than or equal to 6 mm, or any and all sub-ranges formed from any of these endpoints.

As discussed hereinabove, colored glass articles formed from the glass compositions described herein may have an increased fracture toughness such that the colored glass articles are more resistant to damage. In embodiments, the colored glass article may have a K_{1C} fracture toughness as measured by a double torsion method greater than or equal to 0.7 M Pa·m^{1/2}. In embodiments, the colored glass article may have a K_{1C} fracture toughness as measured by a double torsion method greater than or equal to 0.7 M Pa·m^{1/2}, greater than or equal to 0.8 M Pa· m^{1/2}, greater than or equal to 0.9 M Pa·m^{1/2}, or even greater than or equal to 1.0 M Pa·m^{1/2}.

In embodiments, the glass compositions described herein are ion-exchangeable to facilitate strengthening the colored glass article made from the glass compositions. In typical ion-exchange processes, smaller metal ions in the glass compositions are replaced or “exchanged” with larger metal ions of the same valence within a layer that is close to the outer surface of the glass article made from the glass composition. The replacement of smaller ions with larger ions creates a compressive stress within the layer of the glass article made from the glass composition. In embodiments, the metal ions are monovalent metal ions (e.g., Li⁺, Na⁺, K⁺, and the like), and ion-exchange is accomplished by immersing the glass article made from the glass composition in a bath comprising at least one molten salt of the larger metal ion that is to replace the smaller metal ion in the glass article. Alternatively, other monovalent ions such as Ag⁺, Tl⁺, Cu⁺, and the like may be exchanged for monovalent ions. The ion-exchange process or processes that are used to strengthen the glass article made from the glass composition may include, but are not limited to, immersion in a single bath or multiple baths of like or different compositions with washing and/or annealing steps between immersions. In embodiments, the glass articles made from the glass compositions may be ion-exchanged by exposure to molten NaNO₃ salt at a temperature of 500° C. In such embodiments, the Nations replace some portion of the Li⁺ ions in the glass article to develop a surface compressive layer and exhibit high crack resistance. The resulting compressive stress layer may have a depth (also referred to as a “depth of compression” or “DOC”) of at least 100 μm on the surface of the glass article in 2 hours. In embodiments, the bath further comprises molten KNO₃ salt.

In embodiments, a colored glass article made from a glass composition may be ion-exchanged to achieve a depth of compression of 10 μm or greater, 20 μm or greater, 30 μm or greater, 40 μm or greater, 50 μm or greater, 60 μm or greater, 70 μm or greater, 80 μm or greater, 90 μm or greater, or 100 μm or greater. In embodiments, the colored glass article made from the glass composition may have a thickness “t” and may be ion-exchanged to achieve a depth of compression greater than or equal to 0.15 t, greater than or equal to 0.17 t, or even greater than or equal to 0.2 t. In embodiments, the colored glass article made from the glass composition may have a thickness “t” and may be ion-exchanged to achieve a depth of compression less than or equal to 0.3 t, less than or equal to 0.27 t, or even less than or equal to 0.25 t. In embodiments, the colored glass article made from the glass composition described herein may have a thickness “t” and may be ion-exchanged to achieve a depth of compression greater than or equal to 0.15 t and less than or equal to 0.3 t, greater than or equal to 0.15 t and less than or equal to 0.27 t, greater than or equal to 0.15 t and less than or equal to 0.25 t, greater than or equal to 0.17 t and less than or equal to 0.3 t, greater than or equal to 0.17 t and less than or equal to 0.27 t, greater than or equal to 0.17 t and less than or equal to 0.25 t, greater than or equal to 0.2 t and less than or equal to 0.3 t, greater than or equal to 0.2 t and less than or equal to 0.27 t, or even greater than or equal to 0.2 t and less than or equal to 0.25 t, or any and all sub-ranges formed from any of these endpoints.

The development of this surface compression layer is beneficial for achieving a better crack resistance and higher flexural strength compared to non-ion-exchanged materials. The surface compression layer has a higher concentration of the ions exchanged into the colored glass article in comparison to the concentration of the ions exchanged into the colored glass article for the body (i.e., the area not including the surface compression) of the colored glass article. In embodiments, the colored glass article made from the glass composition may have a surface compressive stress after ion-exchange strengthening greater than or equal to 300 M Pa, greater than or equal to 400 M Pa, greater than or equal to 500 M Pa, or even greater than greater than or equal to 600 M Pa. In embodiments, the colored glass article made from the glass composition may have a surface compressive stress after ion-exchange strengthening less than or equal to 1 GPa, less than or equal to 900 M Pa, or even less than or equal to 800 M Pa. In embodiments, the colored glass article made from the glass composition may have a surface compressive stress after ion-exchange strengthening greater than or equal to 300 M Pa and less than or equal to 1 GPa, greater than or equal to 300 M Pa and less than or equal to 900 M Pa, greater than or equal to 300 M Pa and less than or equal to 800 M Pa, greater than or equal to 400 M Pa and less than or equal to 1 GPa, greater than or equal to 400 M Pa and less than or equal to 900 M Pa, greater than or equal to 400 M Pa and less than or equal to 800 M Pa, greater than or equal to 500 M Pa and less than or equal to 1 GPa, greater than or equal to 500 M Pa and less than or equal to 900 M Pa, greater than or equal to 500 M Pa and less than or equal to 800 M Pa, greater than or equal to 600 M Pa and less than or equal to 1 GPa, greater than or equal to 600 M Pa and less than or equal to 900 M Pa, greater than or equal to 600 M Pa and less than or equal to 800 M Pa,

In embodiments, the colored glass articles made from the glass composition may have a central tension after ion-exchange strengthening greater than or equal to 40 M Pa, greater than or equal to 60 M Pa, greater than or equal to 80 M Pa, or even greater than or equal to 100 M Pa. In embodiments, the colored glass article made from the glass composition may have a central tension after ion-exchange strengthening less than or equal to 250 M Pa, less than or equal to 200 M Pa, or even less than or equal to 150 M Pa. In embodiments, the colored glass article made from the glass composition may have a central tension after ion-exchange strengthening greater than or equal to 40 M Pa and less than or equal to 250 M Pa, greater than or equal to 40 M Pa and less than or equal to 200 M Pa, greater than or equal to 40 M Pa and less than or equal to 150 M Pa, greater than or equal to 60 M Pa and less than or equal to 250 M Pa, greater than or equal to 60 M Pa and less than or equal to 200 M Pa, greater than or equal to 60 M Pa and less than or equal to 150 M Pa, greater than or equal to 80 M Pa and less than or equal to 250 M Pa, greater than or equal to 80 M Pa and less than or equal to 200 M Pa, greater than or equal to 80 M Pa and less than or equal to 150 M Pa, greater than or equal to 100 M Pa and less than or equal to 250 M Pa, greater than or equal to 100 M Pa and less than or equal to 200 M Pa, or even greater than or equal to 100 M Pa and less than or equal to 150 M Pa, or any and all sub-ranges formed from any of these endpoints.

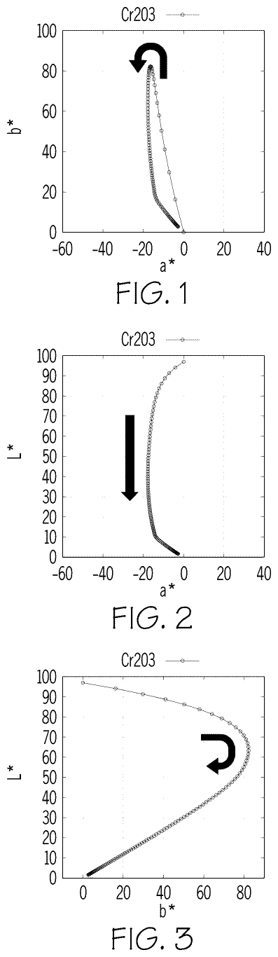

As described herein, the glass compositions described herein increase the solubility of Cr₂O₃, which increases the amount of Cr₂O₃ present in the resultant colored glass articles, thereby expanding the color gamut achievable by the colored glass articles. Referring now to FIGS. 1-3, a projected color gamut for a glass composition including only Cr₂O₃ as a colorant is shown. As illustrated, a single colorant generates a line in the CIELAB color space. The points along the line correspond to different levels of Cr₂O₃ concentration from 0 mol % to 2 mol %. The arrows indicate the directions of increasing concentration. The Cr₂O₃ color gamut projects that a colored glass article having greater than or equal to 0 mol % and less than or equal to 2 mol % Cr₂O₃ may have a transmittance color coordinate in the CIELAB color space, as measured at an article thickness of 1.5 mm under F2 illumination and a 10° standard observer angle, of L* greater than or equal to 0 and less than or equal to 100, a* greater than or equal to −18 and less than or equal to 0, and b* greater than or equal to 0 and less than or equal to 82.

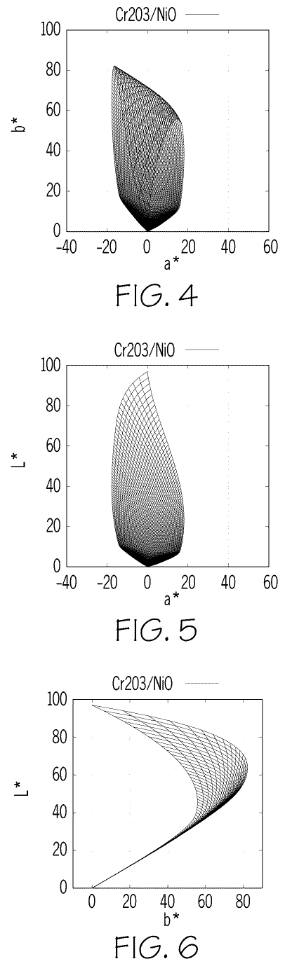

Different color gamuts may be achieved by including other colorants in addition to Cr₂O₃. Referring now to FIGS. 4-6, a projected color gamut for a glass composition including Cr₂O₃ and NiO as colorants is shown. As illustrated, two colorants generate a surface in the CIELAB color space. The Cr₂O₃/NiO color gamut projects that a colored glass article having greater than or equal to 0 mol % and less than or equal to 2 mol % Cr₂O₃ and greater than or equal to 0 mol % and less than or equal to 4 mol % NiO may have a transmittance color coordinate in the CIELAB color space, as measured at an article thickness of 1.5 mm under F2 illumination and a 10° standard observer angle, of L* greater than or equal to 0 and less than or equal to 100, a* greater than or equal to −18 and less than or equal to 18, and b* greater than or equal to 0 and less than or equal to 82.

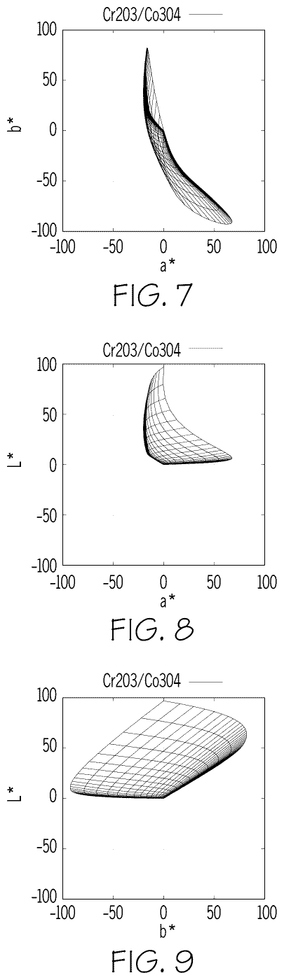

Referring now to FIGS. 7-9, a projected color gamut for a glass composition including Cr₂O₃ and Co₃O₄ as colorants is shown. As illustrated, two colorants generate a surface in the CIELAB color space. The Cr₂O₃/Co₃O₄ color gamut projects that a colored glass article having greater than or equal to 0 mol % and less than or equal to 2 mol % Cr₂O₃ and greater than or equal to 0 mol % and less than or equal to 2 mol % Co₃O₄ may have a transmittance color coordinate in the CIELAB color space, as measured at an article thickness of 1.5 mm under F2 illumination and a 10° standard observer angle, of L* greater than or equal to 0 and less than or equal to 100, a greater than or equal to −20 and less than or equal to 60, and b* greater than or equal to −90 and less than or equal to 85.

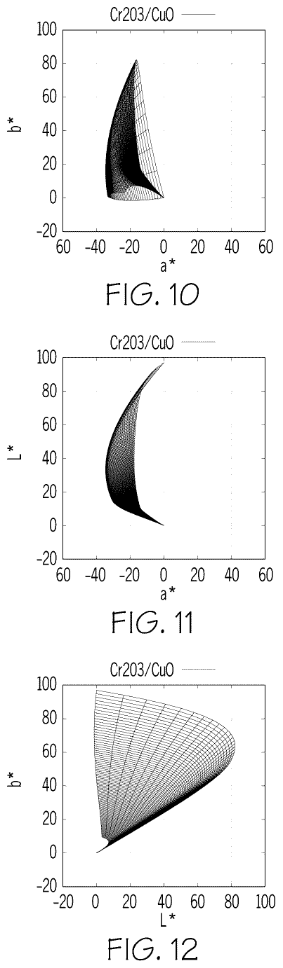

Referring now to FIGS. 10-12, a projected color gamut for a glass composition including Cr₂O₃ and CuO as colorants is shown. As illustrated, two colorants generate a surface in the CIELAB color space. The Cr₂O₃/CuO color gamut projects that a colored glass article having greater than or equal to 0 mol % and less than or equal to 2 mol % Cr₂O₃ and greater than or equal to 0 mol % and less than or equal to 20 mol % CuO may have a transmittance color coordinate in the CIELAB color space, as measured at an article thickness of 1.5 mm under F2 illumination and a 10° standard observer angle, of L* greater than or equal to 0 and less than or equal to 100, a greater than or equal to −35 and less than or equal to 0, and b* greater than or equal to 0 and less than or equal to 82.

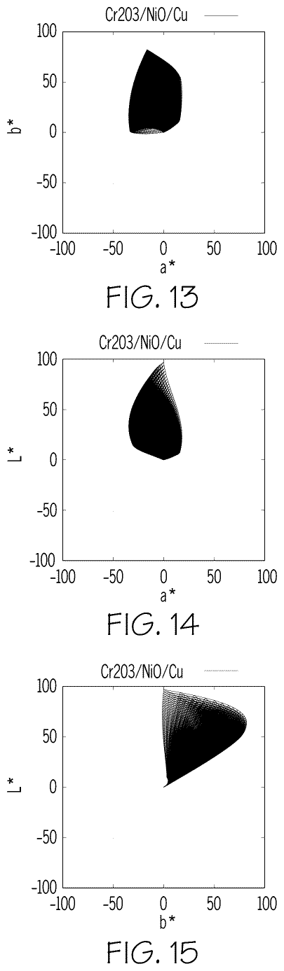

Referring now to FIGS. 13-15, a projected color gamut for a glass composition including Cr₂O₃, NiO, and CuO as colorants is shown. As illustrated, three colorants create a volume in the CIELAB color space. The Cr₂O₃/NiO/CuO color gamut projects that a colored glass article having greater than or equal to 0 mol % and less than or equal to 2 mol % Cr₂O₃, greater than or equal to 0 mol % and less than or equal to 4 mol % NiO, and greater than or equal to 0 mol % and less than or equal to 20 mol % CuO may have a transmittance color coordinate in the CIELAB color space, as measured at an article thickness of 1.5 mm under F2 illumination and a 10° standard observer angle, of L* greater than or equal to 0 and less than or equal to 100, a* greater than or equal to −35 and less than or equal to 20, and b* greater than or equal to 0 and less than or equal to 75.

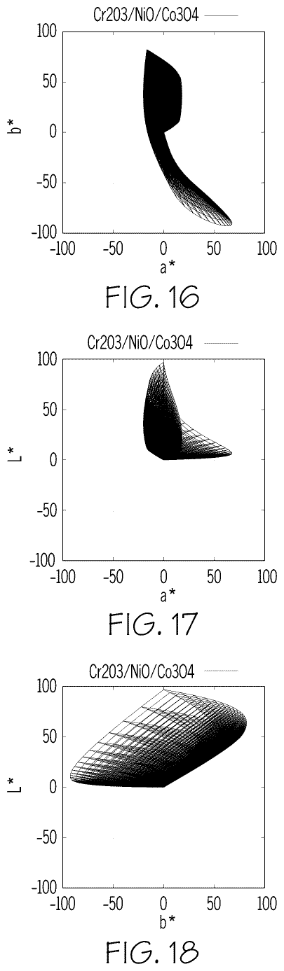

Referring now to FIGS. 16-18, a projected color gamut for a glass composition including Cr₂O₃, NiO, and Co₃O₄ as colorants is shown. As illustrated, three colorants create a volume in the CIELAB color space. The Cr₂O₃/NiO/Co₃O₄ color gamut projects that a colored glass article having greater than or equal to 0 mol % and less than or equal to 2 mol % Cr₂O₃, greater than or equal to 0 mol % and less than or equal to 4 mol % NiO, and greater than or equal to 0 mol % and less than or equal to 2 mol % Co₃O₄ may have a transmittance color coordinate in the CIELAB color space, as measured at an article thickness of 1.5 mm under F2 illumination and a 10° standard observer angle, of L* greater than or equal to 0 and less than or equal to 100, a greater than or equal to −15 and less than or equal to 65, and b* greater than or equal to −90 and less than or equal to 80.

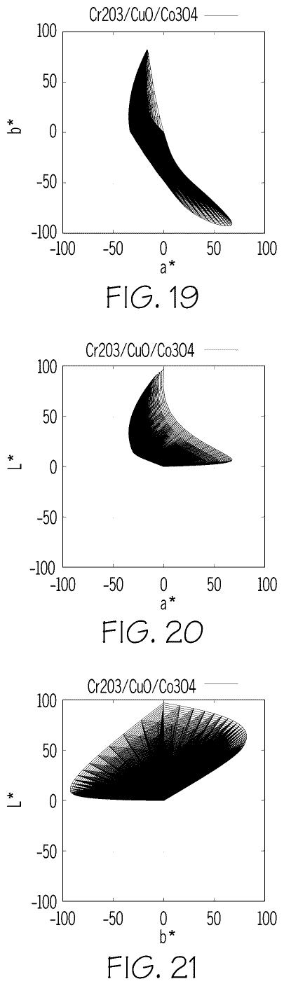

Referring now to FIGS. 19-21, a projected color gamut for a glass composition including Cr₂O₃, CuO, and Co₃O₄ as colorants is shown. As illustrated, three colorants create a volume in the CIELAB color space. The Cr₂O₃/CuO/Co₃O₄ color gamut projects that a colored glass article having greater than or equal to 0 mol % and less than or equal to 2 mol % Cr₂O₃, greater than or equal to 0 mol % and less than or equal to 20 mol % CuO, and greater than or equal to 0 mol % and less than or equal to 2 mol % Co₃O₄ may have a transmittance color coordinate in the CIELAB color space, as measured at an article thickness of 1.5 mm under F2 illumination and a 10° standard observer angle, of L* greater than or equal to 0 and less than or equal to 100, a* greater than or equal to −35 and less than or equal to 60, and b* greater than or equal to −90 and less than or equal to 80.

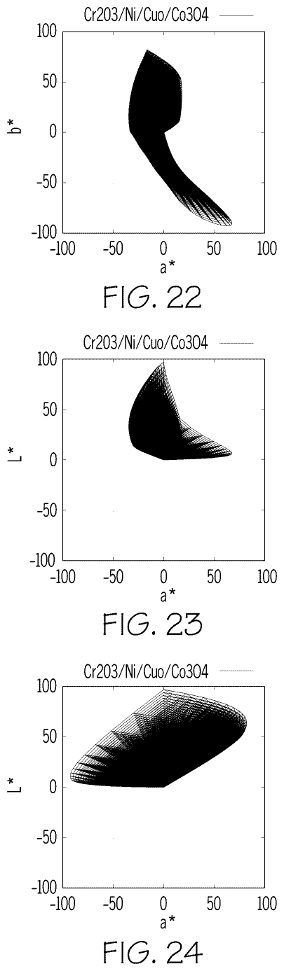

Referring now to FIGS. 22-24, a projected color gamut for a glass composition including Cr₂O₃, NiO, CuO, and Co₃O₄ as colorants is shown. As illustrated, three colorants create an overlapping volume in the CIELAB color space. The Cr₂O₃/NiO/CuO/Co₃O₄ color gamut projects that a colored glass article having greater than or equal to 0 mol % and less than or equal to 2 mol % Cr₂O₃, greater than or equal to 0 mol % and less than or equal to 4 mol % NiO, greater than or equal to 0 mol % and less than or equal to 20 mol % CuO, and greater than or equal to 0 mol % and less than or equal to 2 mol % Co₃O₄ may have a transmittance color coordinate in the CIELAB color space, as measured at an article thickness of 1.5 mm under F2 illumination and a 10° standard observer angle, of L* greater than or equal to 0 and less than or equal to 100, a* greater than or equal to −35 and less than or equal to 60, and b* greater than or equal to −90 and less than or equal to 80.

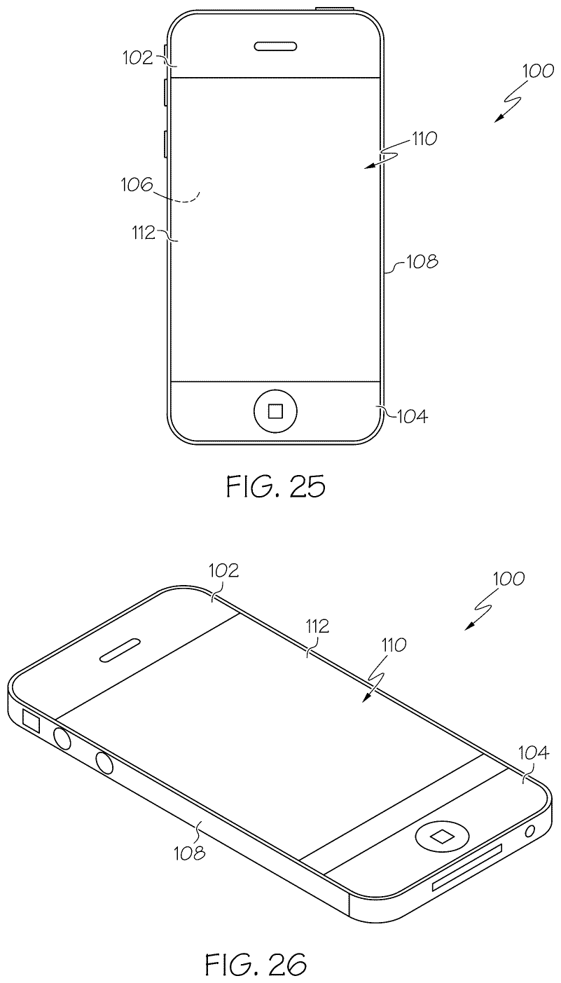

The colored glass articles described herein may be used for a variety of applications including, for example, back cover applications in consumer or commercial electronic devices such as smartphones, tablet computers, personal computers, ultrabooks, televisions, and cameras. An exemplary article incorporating any of the colored glass articles disclosed herein is shown in FIGS. 25 and 26. Specifically, FIGS. 25 and 26 show a consumer electronic device 100 including a housing 102 having front 104, back 106, and side surfaces 108; electrical components (not shown) that are at least partially inside or entirely within the housing and including at least a controller, a memory, and a display 110 at or adjacent to the front surface of the housing; and a cover substrate 112 at or over the front surface of the housing such that it is over the display. In embodiments, a portion of housing 102, such as the back 106, may include any of the colored glass articles disclosed herein.

### Examples

In order that various embodiments be more readily understood, reference is made to the following examples, which illustrate various embodiments of the colored glass articles described herein.

Table 1 shows example glass compositions (in terms of mol %) and the transmittance color coordinate in the CIELAB color space, as measured at an article thickness of 1.5 mm under F2 illumination and a 10° standard observer angle, of the resultant colored glass articles.

TABLE 1

| Example | 1 | 2 | 3 | 4 | 5 | 6 |
|---|---|---|---|---|---|---|
| SiO₂ | 58.78 | 58.30 | 58.52 | 58.97 | 58.26 | 58.52 |
| Al₂O₃ | 16.68 | 16.35 | 16.50 | 16.41 | 16.38 | 16.56 |
| B₂O₃ | 5.93 | 5.93 | 6.01 | 5.98 | 5.93 | 6.04 |
| Li₂O | 11.74 | 9.86 | 9.93 | 9.89 | 9.85 | 9.89 |
| Na₂O | 6.26 | 4.25 | 4.27 | 4.27 | 4.26 | 4.30 |
| K₂O | 0.48 | 0.48 | 0.48 | 0.49 | 0.48 | 0.49 |
| MgO | 0.02 | 2.91 | 2.95 | 2.91 | 2.94 | 2.93 |
| CaO | 0.01 | 0.01 | 0.01 | 0.01 | 0.01 | 0.02 |
| ZnO | — | 1 | 1.01 | 1 | 1 | 1.05 |
| TiO₂ | 0.01 | 0.01 | 0.01 | 0.01 | 0.01 | 0.01 |
| NiO | — | — | 0.023 | 0.012 | 0.043 | 0.089 |
| Co₃O₄ | — | 0.001 | 0.002 | 0.002 | 0.03 | 0.048 |
| CuO | — | 0.83 | 0.233 | 0.037 | 0.785 | 0.044 |
| Cr₂O₃ | 0.098 | 0.068 | 0.038 | 0.002 | 0.016 | 0.008 |
| R₂O | 18.48 | 14.59 | 14.68 | 14.65 | 14.59 | 14.68 |
| RO | 0.03 | 3.92 | 3.97 | 3.92 | 3.95 | 4 |
| R₂O + | 1.83 | 2.16 | 2.15 | 2.16 | 2.16 | 2.12 |
| RO − Al₂O₃ | | | | | | |
| MgO + ZnO | 0.02 | 3.91 | 3.96 | 3.91 | 3.94 | 3.98 |
| Al₂O₃ + | 16.7 | 20.26 | 20.46 | 20.32 | 20.32 | 20.54 |
| MgO + ZnO | | | | | | |

Transmittance Color Coordinate

| L* | 83.78 | 77.06 | 85.88 | 94.99 | 66.99 | 62.17 |
|---|---|---|---|---|---|---|
| a* | −12.60 | −26.24 | −9.49 | −0.45 | −10.12 | −2.12 |
| b* | 62.26 | 8.74 | 6.26 | 0.17 | −14.19 | −20.39 |
| Example | 7 | 8 | 9 | 10 | 11 | 12 |
| SiO₂ | 57.09 | 59.21 | 58.44 | 58.12 | 59.20 | 58.36 |
| Al₂O₃ | 16.10 | 16.64 | 16.21 | 16.56 | 16.58 | 16.11 |
| B₂O₃ | 5.90 | 5.62 | 5.70 | 6.07 | 5.67 | 5.69 |
| Li₂O | 9.68 | 11.75 | 11.56 | 11.83 | 11.82 | 11.6 |
| Na₂O | 4.21 | 6.18 | 6.09 | 6.21 | 6.16 | 6.07 |
| K₂O | 0.47 | 0.47 | 0.47 | 0.48 | 0.45 | 0.46 |
| MgO | 2.86 | 0.02 | 0.02 | 0.02 | 0.02 | 0.02 |
| CaO | 0.02 | 0.01 | 0.01 | 0.01 | 0.01 | 0.01 |
| ZnO | 0.98 | — | — | — | — | — |
| TiO₂ | — | 0.01 | — | 0.01 | 0.01 | — |
| NiO | 0.014 | 0.078 | 0.039 | 0.071 | — | — |
| Co₃O₄ | 0.058 | 0.001 | 0.001 | 0.002 | 0.002 | 0.038 |
| CuO | 2.598 | 0.002 | 1.351 | 0.563 | 0.086 | 1.583 |
| Cr₂O₃ | 0.006 | 0.009 | 0.102 | 0.051 | 0.002 | 0.051 |
| R₂O | 14.36 | 18.4 | 18.12 | 18.52 | 18.43 | 18.13 |
| RO | 3.86 | 0.03 | 0.03 | 0.03 | 0.03 | 0.03 |
| R₂O + | 2.12 | 1.79 | 1.94 | 1.99 | 1.88 | 2.05 |
| RO − Al₂O₃ | | | | | | |
| MgO + ZnO | 3.84 | 0.02 | 0.02 | 0.02 | 0.02 | 0.02 |
| Al₂O₃ + | 19.94 | 16.66 | 16.23 | 16.58 | 16.6 | 16.13 |
| MgO + ZnO | | | | | | |

Transmittance Color Coordinate

| L* | 38.41 | 89.31 | 89.27 | 76.84 | 94.52 | 41.28 |
|---|---|---|---|---|---|---|
| a* | −14.36 | −0.65 | −0.77 | −14.83 | −1.14 | −18.17 |
| b* | −13.36 | 17.15 | 17.45 | 11.73 | −2.04 | −13.89 |
| Example | 13 | 14 | 15 | 16 | 17 | 18 |
| SiO₂ | 58.03 | 58.39 | 58.48 | 58.45 | 58.58 | 58.71 |
| Al₂O₃ | 16.57 | 16.49 | 16.53 | 16.49 | 16.42 | 16.54 |
| B₂O₃ | 6.03 | 6.01 | 6.09 | 6.04 | 5.97 | 5.99 |
| Li₂O | 11.93 | 10.02 | 10.08 | 10.04 | 10.5 | 10.48 |
| Na₂O | 6.23 | 4.28 | 4.26 | 4.25 | 4.71 | 4.76 |
| K₂O | 0.48 | 0.48 | 0.49 | 0.48 | 0.48 | 0.49 |
| MgO | 0.02 | 2.95 | 2.94 | 2.94 | 0.96 | 0.97 |
| CaO | 0.01 | 0.02 | 0.01 | 0.02 | 0.98 | 0.98 |
| ZnO | — | 1.01 | 1.01 | 1.01 | 0.99 | 1.02 |
| TiO₂ | 0.01 | 0.01 | 0.01 | 0.01 | 0.01 | 0.01 |
| NiO | 0.093 | 0.021 | — | 0.082 | 0.019 | — |
| Co₃O₄ | 0.072 | 0.002 | 0.002 | 0.048 | 0.002 | 0.002 |
| CuO | 0.516 | 0.278 | 0.091 | 0.137 | 0.339 | 0.054 |
| Cr₂O₃ | 0.012 | 0.036 | 0.001 | 0.006 | 0.039 | 0.001 |
| R₂O | 18.64 | 14.78 | 14.83 | 14.77 | 15.69 | 15.73 |
| RO | 0.03 | 3.98 | 3.96 | 3.97 | 2.93 | 2.97 |
| R₂O + | 2.1 | 2.27 | 2.26 | 2.25 | 2.2 | 2.16 |
| RO − Al₂O₃ | | | | | | |
| MgO + ZnO | 0.02 | 3.96 | 3.95 | 3.95 | 1.95 | 1.99 |
| Al₂O₃ + | 16.59 | 20.45 | 20.48 | 20.44 | 18.37 | 18.53 |
| MgO + ZnO | | | | | | |

Transmittance Color Coordinate

| | | | | | | |
|---|---|---|---|---|---|---|
| L* | 38.93 | 85.89 | 95.05 | 62.68 | 85.25 | 95.29 |
| a* | 1.10 | −9.54 | −0.84 | −2.13 | −10.39 | −0.68 |
| b* | −44.38 | 5.68 | −0.62 | −20.72 | 6.20 | −0.90 |

| Example | 19 |
|---|---|
| SiO₂ | 58.51 |
| Al₂O₃ | 16.49 |
| B₂O₃ | 6.06 |
| Li₂O | 10.47 |
| Na₂O | 4.76 |
| K₂O | 0.49 |
| MgO | 0.97 |
| CaO | 0.99 |
| ZnO | 1.01 |
| TiO₂ | 0.01 |
| NiO | 0.085 |
| Co₃O₄ | 0.048 |
| CuO | 0.111 |
| Cr₂O₃ | 0.005 |
| R₂O | 15.72 |
| RO | 2.97 |
| R₂O + | 2.2 |
| RO − Al₂O₃ | |
| MgO + ZnO | 1.98 |
| Al₂O₃ + | 18.47 |
| MgO + ZnO | |

Transmittance Color Coordinate

| | |
|---|---|
| L* | 61.08 |
| a* | −2.34 |
| b* | −22.51 |

As indicated by the example glass compositions and colored glass articles in Table 1, the glass compositions described herein improve Cr₂O₃ solubility to form colored glass articles having the desired color. For example, example glass composition 1 including 0.098 mol % Cr₂O₃ formed a colored glass article having a transmittance color coordinate in the CIELAB color space of L*=83.78, a*=−12.60, and b*=62.26.

As further indicated by the example glass compositions and colored glass articles in Table 1, adding other colorants in addition to Cr₂O₃ as described herein allows different color gamuts to be achieved. For example, example glass composition 2 including 0.068 mol % Cr₂O₃, 0.001 mol % Co₃O₄, and 0.83 mol % CuO formed a colored glass article have a transmittance color coordinate in the CIELAB color space of L*=77.06, a*=−26.24, and b*=8.74. Example glass composition 3, including 0.038 mol % Cr₂O₃, 0.023 mol % NIO, 0.002 mol % Co₃O₄, and 0.233 mol % CuO formed a colored glass article have a transmittance color coordinate in the CIELAB color space of L*=85.88, a*=−9.40, and b*=6.26.

It will be apparent to those skilled in the art that various modifications and variations may be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1. A colored glass article comprising:
greater than or equal to 50 mol % and less than or equal to 70 mol % SiO₂;
greater than or equal to 10 mol % and less than or equal to 17.5 mol % Al₂O₃;
greater than or equal to 3 mol % and less than or equal to 10 mol % B₂O₃;
greater than or equal to 8.8 mol % and less than or equal to 14 mol % Li₂O;
Na₂O in a non-zero amount of less than or equal to 8 mol %;
less than or equal to 1 mol % K₂O; and
greater than 0 mol % and less than or equal to 2 mol % Cr₂O₃, wherein:
R₂O+RO−Al₂O₃ is greater than or equal to 0.5 mol % and less than or equal to 6 mol %, wherein R₂O is the sum of Li₂O, Na₂O, and K₂O and RO is the sum of MgO, ZnO, and CaO; and
Al₂O₃+MgO+ZnO is greater than or equal to 12 mol % and less than or equal to 22 mol %.

2. The colored glass article of claim 1, wherein the colored glass article has a transmittance color coordinate in the CIELAB color space, as measured at an article thickness of 1.5 mm under F2 illumination and a 10° standard observer angle, of:
L* greater than or equal to 0 and less than or equal to 100;
a* greater than or equal to −18 and less than or equal to 0; and
b* greater than or equal to 0 and less than or equal to 82.

3. The colored glass article of claim 1, wherein MgO+ZnO is greater than or equal to 0 mol % and less than or equal to 4.5 mol %.

4. The colored glass article of claim 1, wherein R₂O+RO−Al₂O₃ is greater than or equal to 1 mol % and less than or equal to 5.5 mol %.

5. The colored glass article of claim 1, wherein Al₂O₃+MgO+ZnO is greater than or equal to is greater than or equal to 13 mol % and less than or equal to 21.5 mol %.

6. The colored glass article of claim 1, wherein the colored glass article comprises greater than or equal to 0.001 mol % and less than or equal to 1.5 mol % Cr₂O₃.

7. The colored glass article of claim 1, wherein the colored glass article comprises greater than or equal to 12 mol % and less than or equal to 17.25 mol % Al₂O₃.

8. The colored glass article of claim 1, wherein the colored glass article comprises greater than or equal to 3.5 mol % and less than or equal to 9 mol % B₂O₃.

9. The colored glass article of claim 1, wherein the colored glass article comprises NIO, CuO, Co₃O₄, or combinations thereof.

10. The colored glass article of claim 1, wherein the colored glass article has a K_{1C} fracture toughness as measured by a chevron notch short bar method of greater than or equal to 0.7M Pa*m^{0.5}.

11. The colored glass article of claim 1, wherein the colored glass article is a chemically strengthened glass article.

12. The colored glass article of claim 11, wherein the colored glass article has a surface compressive stress greater than or equal to 300 M Pa.

13. The colored glass article of claim 11, wherein the colored glass article has a maximum central tension greater than or equal to 40 M Pa.

14. The colored glass article of claim 11, wherein the colored glass article has a depth of compression greater than or equal to 0.15 t, where t is the thickness of the colored glass article.

15. A glass composition comprising:
greater than or equal to 50 mol % and less than or equal to 70 mol % SiO₂;
greater than or equal to 10 mol % and less than or equal to 17.5 mol % Al₂O₃;
greater than or equal to 3 mol % and less than or equal to 10 mol % B₂O₃;
greater than or equal to 8.8 mol % and less than or equal to 14 mol % Li₂O;
Na₂O in a non-zero amount of less than or equal to 8 mol % Na₂O;
less than or equal to 1 mol % K₂O; and
greater than 0 mol % and less than or equal to 0.2 mol % Cr₂O₃, wherein:
R₂O+RO−Al₂O₃ is greater than or equal to 0.5 mol % and less than or equal to 6 mol %, wherein R₂O is the sum of Li₂O, Na₂O, and K₂O and RO is the sum of MgO, ZnO, and CaO; and
Al₂O₃+MgO+ZnO is greater than or equal to 12 mol % and less than or equal to 22 mol %.

16. The glass composition of claim 15, wherein MgO+ZnO is greater than or equal to 0 mol % and less than or equal to 4.5 mol %.

17. The glass composition of claim 15, wherein R₂O+RO−Al₂O₃ is greater than or equal to 1 mol % and less than or equal to 5.5 mol %.

18. The glass composition of claim 15, wherein Al₂O₃+MgO+ZnO is greater than or equal to is greater than or equal to 14 mol % and less than or equal to 20 mol %.

19. The glass composition of claim 15, wherein the glass composition comprises greater than or equal to 0.001 mol % and less than or equal to 1.5 mol % Cr₂O₃.

20. The glass composition of claim 15, wherein the glass composition comprises greater than or equal to 12 mol % and less than or equal to 17 mol % Al₂O₃.
